(19) United States
(12) Patent Application Publication
(10) Pub. No.: US 2019/0392724 A1
(43) Pub. Date: Dec. 26, 2019

(54) Secure Testing Device

(71) Applicant: Intelligent Technologies International, Inc., Miami Beach, FL (US)

(72) Inventors: David S. Breed, Miami Beach, FL (US); Wilbur E. DuVall, Katy, TX (US); Oleksandr Shostak, Kyiv (UA); Serhii Shostak, Kyiv (UA); Vyacheslav Sokurenko, Kyiv (UA); Wendell C. Johnson, San Pedro, CA (US)

(73) Assignee: Intelligent Technologies International, Inc., Miami Beach, FL (US)

(21) Appl. No.: 16/564,905

(22) Filed: Sep. 9, 2019

Related U.S. Application Data
(63) Continuation-in-part of application No. 16/107,164, filed on Aug. 21, 2018, now Pat. No. 10,410,535.
Application No. 16/107,164 is a continuation-in-part of application No. 15/964,208, filed on Apr. 27, 2018, now abandoned.
Application No. 15/964,208 is a continuation of application No. 15/329,243, filed on Jan. 25, 2017, now Pat. No. 9,959,777.
(60) Provisional application No. 62/668,965, filed on May 9, 2018.
(60) Provisional application No. 62/644,897, filed on Mar. 19, 2018.
(60) Provisional application No. 62/040,806, filed on Aug. 22, 2014.

(51) Int. Cl. G09B 7/07; G02B 27/01; G06K 9/00; G10L 17/00; H04N 5/247

(52) U.S. Cl. CPC G09B 7/07; G02B 27/0176; G06K 9/00604; G06K 9/00617; G02B 2027/014; H04N 5/247; G02B 2027/0178; G02B 2027/0138; G10L 17/005

(57) ABSTRACT

Secure testing system including a frame having a lens portion and a support portion extending rearward therefrom, a housing attached to the frame, and an assembly arranged in the housing. The assembly includes a display oriented rearward, an optional (but preferred) contact microphone that operatively contacts a face of a wearer and detects vibrations of a bone of the wearer, a biometric sensor arranged at least partly in the housing, and a processor that monitors the contact microphone for vibrations and the biometric sensor for changes in biometric data. For testing, the processor directs display of questions on the display, receives answers via a user interface, confirms identity of a test-taker by analyzing biometric data and detects talking by the test-taker indicative of cheating on the test by monitoring vibrations detected by the contact microphone.

### FIELD OF THE INVENTION

The present invention relates generally to the field of a computer-based system and method for taking a test while ensuring that the test-taker is not receiving assistance from another person or otherwise cheating while taking the test, and that a device used for displaying or taking the test has not been breached and is not being breached or otherwise compromised.

### BACKGROUND OF THE INVENTION

There is significant discussion over the past several years relating to MOOCs, Massive Open Online Courses. Using the Internet, education can be freely distributed to anyone who has Internet access. Mastery of almost any field taught in colleges and universities can be achieved by a motivated student without attending lectures at that college or university. Thus, technology is in place for a student to obtain at virtually no cost the knowledge that has previously only been available to a campus-resident, matriculated student at a college, university or other institution.

In contrast, the cost of a traditional Massachusetts Institute of Technology (MIT) education, for example, resulting in a bachelor's degree can approach or exceed two hundred thousand dollars. The only impediment which exists from preventing a university such as MIT from granting a degree to an online-taught student is that the university needs to know with absolute certainty that the student did not cheat when taking various examinations required to demonstrate mastery of the coursework. With a degree from MIT, for example, industry will hire such a person at a starting salary approaching or exceeding $100,000 per year. Thus, the value to the student is enormous. Since the information which must be mastered is now available for free on the Internet, the main impediment separating a motivated and capable student from a high starting salary is that a degree-granting university must be certain that the student has demonstrated mastery of the material through successful completion of examinations without the assistance of a helper or consultant while taking the examinations.

Even when examinations are administered in a classroom, it is well known that extensive cheating can occur. In China, for example, where admission to college is solely determined by the score that a student receives on a one-time examination, motivation to cheat is enormous.

U.S. Pat. No. 5,565,316 (Kershaw et al.) describes a system and method for computer-based testing. A test development system produces a computerized test, and a test delivery system delivers the computerized test to an examinee's workstation. The method comprises producing a computerized test, delivering the computerized test to an examiner and recording examinee responses to questions presented to the examinee during the delivery of the computerized test. A method of delivering a computerized test is also provided in which a standardized test is created, an electronic form of the test is then prepared, the items of the test are presented to an examinee on a workstation display and the examinee's responses are accepted and recorded. A method of administering a computerized test is further provided in which a computerized test is installed on a workstation and then the delivery of the test to an examinee is initiated.

U.S. Pat. No. 5,915,973 (Hoehn-Saric et al.) describes a system for controlling administration of remotely proctored, secure examinations at a remote test station, and a method for administering examinations. The system includes a central station, a registration station and a remote testing station. The central station includes (a) storage device for storing data, including test question data and verified biometric data, and (b) a data processor, operably connected to the storage device, for comparing test-taker biometric data with stored, verified biometric data. The remote test station includes (a) a data processor, (b) a data storage device, operably connected to the data processor, for storing input data, (c) a biometric measurement device for inputting test-taker biometric data to the processor, (d) a display for displaying test question data, (e) an input for inputting test response data to the processor, (f) a recorder for recording proctoring data of a testing event, and (g) a communication link for communicating with the central station, for receiving test question data from the central station, and for communicating test-taker biometric data, test response data, and proctoring data to the central station. Verification of the test-taker and validation of the results are performed before or after the testing event.

U.S. Pat. No. 5,947,747 (Walker et al.) describes methods and apparatus for computer-based evaluation of a test-taker's performance with respect to selected comparative norms. The system includes a home testing computer for transmitting the test-taker's test results to a central computer which derives a performance assessment of the test-taker. The performance assessment can be standardized or customized, as well as relative or absolute. The transmitted test results reliably associate the student with his test results, using encoding, user identification, or corroborative techniques to deter fraud. For example, the system allows a parentally-controlled reward system such that children who reach specified objectives can claim an award that parents are confident was fairly and honestly earned without the parent being required to proctor the testing. Fraud, and the need for proctoring, is also deterred during multiple students testing via an option for simultaneous testing of geographically dispersed test-takers.

U.S. Pat. No. 7,069,586 (Winneg et al.) describes a method and system for securely executing an application on a computer system such that a user cannot access or view unauthorized content available on or accessible using the computer system. To securely execute the application, such method and system may terminate any unauthorized processes executing (i.e., running) on the computer system application prior to execution of the application, and may configure the application such that unauthorized content cannot be accessed, including configuring the application such that unauthorized processes cannot be initiated (i.e., launched) by the application. Further, such system and method terminates any unauthorized processes detected during execution of the application and disables any functions of the computer system that can access unauthorized content, including disabling any functions capable of initiating processes on the computer system. The application being securely executed may be any of a variety of types of applications, for example, an application for receiving answers to questions of an examination (i.e., an exam-taking application). Securely executing an application may be used for purposes, including to assist preventing students from cheating on exams, to assist preventing students from not paying attention in class, to assist preventing employees from wasting time at work, and to assist preventing children from viewing content that their parents deem inappropriate.

U.S. Pat. No. 7,257,557 (Hulick) describes a method, program and system for administering tests in a distributed data processing network in which predetermined test content and multimedia support material are combined into a single encrypted test file. The multimedia support may include visual and audio files for presenting test questions. The encrypted test file is exported to at least one remote test location. The test locations import and decrypt the encrypted test file and load the test content and multimedia support material into a local database. The test is administered on client workstations at the testing location, wherein the test may include audio questions and verbal responses by participants. During testing, biometric data about test participants is recorded and associated with the test files and participant identification. After the test is completed, the completed test results, including verbal responses and biometric data, are combined into a single encrypted results file exported to a remote evaluation location. The evaluation location imports and decrypts the encrypted results file and loads the test results into a local database for grading.

U.S. Pat. Appln. Publ. No. 2007/0117083 (Winneg et al.) describes systems, methods and apparatus for remotely monitoring examinations. Examinations are authored and rules are attributed to the exams that determine how the exams are to be administered. Proctors monitor exam takers from remote locations by receiving data indicative of the environment in which the exam takers are completing the exams. A remote exam monitoring device captures video, audio and/or authentication data and transmits the data to a remote proctor and data analysis system.

In spite of these and other patents and applications that describe methods of preventing cheating on examinations, a brief Google search reveals that cheating on examinations is prevalent worldwide. Thus, these inventions have not been successful in eliminating cheating on examinations. For example, recently students taking examinations for credit in connection with MOOCs have found that they can register many times for a course, and collect and combine the results of multiple simultaneous examinations to compose a single correctly answered test for submission for credit. This is known as Cameo cheating.

The following companies provide proctor services during exam/tests:
ProctorU
https://www.proctoru.com/
Kryterion—acquired by Pearson in 2015
https://www.onlineproctoring.com/
Examity
http://examity.com/
Pearson Vue—both online proctored test and a network of physical test centers
https://home.pearsonvue.com/
Proctorio
https://proctorio.com
B Virtual Inc.
https://bvirtualinc.com/
Question Mark Online Proctoring
https://www.questionmark.com/content/online-proctoring-service

These companies have a similar sequence of the services provided: proctor identifies test-taker person (using test-taker's passport or any other documents); proctor continues to observe the testing session (all sessions are video recorded, desktop of the test-taker computer will be also recorded), and proctor checks the test-taker during the test (it can be made in a way of questioning the test-taker or audio signals that ring at certain times).

According to the presentation of Kryterion company: “ . . . After the proctor verifies that your ID matches your image appearing on their web camera, they will ask you to answer a few security questions. These will further ensure that the correct person is taking the exam.”

So, basically, ‘cheating’ means receiving test answers while proctor observes test-taker sitting in front of the computer.

Cheating consists of two stages: interception of unique test questions and receiving answers to test questions. Receiving answers can be much easier for a cheating test-taker than intercepting information from a company that sent special tests to the examinee.

Online proctored testing (almost all of the above-mentioned companies) allow test-takers to take and pass exams from their homes. This fact increases the possibility of cheating.

Receiving answers which won't be noticed by proctors can be made by the following ways: answers are depicted at tablet or smartphone located behind (or near) the monitor; projection of the answers to any surface (wall, screen, etc.) behind the monitor are also used (FIG. 1); using a compact Morse code transmitter by touching the skin of the test-taker; micro-earpiece located in the ear, vibrations in the seat, bone speaker attached to the test-taker's shoulder (or other bone) underneath clothes, etc.

Question interception can be affected by hidden micro cameras (located in the wall or at the test-taker's clothes) which capture the monitor screen with answers on it and send it to test-taker's consultant. Alternatively, it can be affected by a transmitter which captures video signals from the system unit to the monitor, and be located in conjunction with monitor wires, and then sent to the consultant.

As generally used herein, a “test” is any type of question-based application that requires analysis by a person taking the test and a response from this person. A test may therefore be considered an examination, a quiz, an assessment, an evaluation, a trial and/or an analysis.

### SUMMARY OF THE INVENTION

The present invention is directed at addressing and ideally solving the problem of guaranteeing with high certainty that a test-taker taking a test is acting alone without the aid of a consultant or other helper or otherwise cheating.

An arrangement for test-taking in accordance with a preferred embodiment of the invention includes a head-wearable device which includes at least one sound or vibration sensor for detecting sound or vibration, at least one optical imaging device that obtains images of an area viewed by the test-taker, at least one optical imaging device that obtains images of the iris, retina, or face portion, and a display which is only viewable by the test-taker. Hereinafter, the term iris camera will mean any imaging device which images the iris, retina, or face portion around and including the eye. The display can be a light emitting display such as an LED, LCOS or OLED, a light reflective display or a retinal projector display. A processing unit is coupled to the sensor(s) and imaging device(s) and receives and analyzes data therefrom to determine whether the test-taker is interacting with another person, including whether the test-taker is communicating with another person. The processing unit also decrypts tests questions sent to it for display on the display.

A headpiece in accordance with one embodiment of the invention includes a frame having a support portion adapted to be supported on a person's head and a viewable portion adapted to present visual data or content to the person when the support portion is supported on the person's head. This headpiece may be of the type like, for example, Google Glass™. A self-contained electronics assembly includes at least one imaging device and a display, and is arranged on a frame similar to a glasses frame and obtains images of the environment in front of the person when worn on the person's head. A processor is arranged within the self-contained electronics assembly mounted on the frame and can be coupled to a remote server and/or a computing device such as a smartphone, personal computer, laptop or tablet. The processor is configured to control content of the viewable portion based on input received from the remote server or connected computing device. At least one audio or contact microphone is integral with the electronics assembly which detects audio or vibrational communications, or talking or other sound emission by the test-taker. The processor monitors detection of sound by the microphone(s) and images obtained by the imaging device(s) when the viewable portion is displaying a test to determine whether a person other than the person on which the frame is supported is present or providing information to the test-taker or that the test-taking person is talking or making other sounds. The contact microphone may be used as a user interface in which case, the processor monitors detection of sound or vibration by the contact microphone when the viewable portion is displaying a test, or at other times.

A method for detecting an attempt to physically gain access to or alter the electronics assembly in accordance with one embodiment of the invention is a type of chassis intrusion detector. In the method, the device is enclosed by a film onto which is deposited a labyrinth of conductive wires comprising a continuous circuit. The resistance, capacitance and/or inductance of the circuit is monitored for a break in the circuit which would correlate with (be considered) any attempt to breach the electronics and sensor assembly.

The security assembly can include a processor, a power source for providing power to the processor and a volatile RAM assembly containing private executable code or information such as a required security code, or private key, or other private information or code for use of the device for test-taking purposes. The security assembly is configured such that any attempt to disassemble the security assembly will break one or more wires connecting the power source to the RAM or cause a change in capacitance, resistance or inductance relative to a threshold which will cause the private information to be erased from the RAM assembly. The security assembly is coupled to the electronics assembly which, with the security assembly, resides within the space enclosed by the film with the wire labyrinth. An aperture is provided in the envelope defined by the wire labyrinth in which the electronics assembly is placed, the aperture permitting a wire to connect the electronics assembly to a source of power, an external server or computing device or the Internet. The wire labyrinth is sufficiently transparent as to permit the camera(s) to obtain images therethrough and permit viewing of the display by the test-taker.

An intrusion-protected electronic device in accordance with one embodiment of the invention includes an envelope defined by a wire labyrinth, that encloses the electronics assembly including the security assembly coupled to the film and that periodically measures the capacitance, resistance and/or inductance of the wire labyrinth. The security assembly is configured to monitor the measured capacitance, resistance and/or inductance to determine changes in one of these properties, changes in any of these properties being correlated with an attempt to breach or alter the device.

Additional devices which can be part of the electronics assembly and which are designed to operate through the security film include:
1. A camera for obtaining iris, retinal or partial facial scans.
2. A microphone for monitoring sound in the vicinity of the test-taker or emitted by the test-taker.
3. A sound maker used for testing the microphone sensitivity.
4. A camera for monitoring the area between the display and the test-taker's eye.
5. A contact microphone for detecting sound emanating from the mouth of the test-taker, primarily talking, i.e., words.
6. A contact speaker for testing that the contact microphone is in contact with the test-taker's skin.
7. A device mounted in connection with the contact microphone for detecting the presence of the test-taker's skin. Such a device can comprise a blood flow sensor comprising a LED and light sensor positioned so that the reflection of the LED is in the field of view of the light sensor only when the device is in close proximity to the skin.

### BRIEF DESCRIPTION OF THE DRAWINGS

The following drawings are illustrative of embodiments of the system developed or adapted using the teachings of at least one of the embodiments disclosed herein and are not meant to limit the scope of the disclosure as encompassed by the claims.

FIG. 1 illustrates possible cheating methods used by test-taker.

FIGS. 2 and 3 show forward and back views of a monitor device of the invention, respectively.

FIGS. 4 and 5 illustrate cutaway views of a monitor of the invention.

FIG. 6 is a chassis intrusion detector design and its assembly sequence.

FIG. 7 shows the unassembled monitor housing.

FIG. 8 shows the chassis intrusion detector operating principle.

FIGS. 9 and 10 illustrate a monitor device when worn by a person.

FIG. 11 illustrates a monitor block diagram.

FIG. 12 illustrates a system block diagram.

FIG. 13 illustrates a representative administrative sequence.

FIG. 14 illustrates a representative test-taking sequence.

FIG. 15 illustrates a representative biometric block diagram.

FIG. 16 illustrates a monitor connected to a power and Wi-Fi module which plugs into wall.

FIG. 17 illustrates a situation where the monitor plugs into a smartphone.

FIG. 18 shows the monitor with associated mouse and keyboard.

FIG. 19 illustrates an optics detail showing one method of nearsightedness and farsightedness adjustment and nose rest adjustment.

FIG. 20 is a 3D-diagram of the display and iris-scanner module.

FIG. 21 illustrates the ray path in the display channel.

FIG. 22 shows the ray path for the iris-scan camera.

FIG. 23 is a lens prescription data.

FIG. 24 shows an alternative type of monitor frame.

FIGS. 25 and 26 show devices based on standard glasses with one lens remaining.

FIGS. 27, 28, 29 and 30 illustrate another preferred version of a monitor in accordance with the invention.

FIG. 31 illustrates a method of attaching a USB connector for supplying power to the monitor through the CID.

FIGS. 32 and 33 illustrate use of a contact speaker with a contact microphone to verify that the contact speaker contacts the test-taker's face and further, use of an EKG biometric for additional verification of proper placement of the contact microphone and to obtain an additional biometric.

FIGS. 34 and 35 illustrate methods of cheating proctored exams.

FIG. 36 illustrates the use of the apparatus in accordance with the invention by a room full of test-takers where each device is attached to a central computer through a USB port.

FIG. 37 is a view similar to FIG. 36 with a wireless connection through a wireless transmitter box associated with each desk and where the test-takers are using paper to record their test answers.

FIG. 38A is a perspective view of a head worn glasses type device containing an electronics assembly with several sensors, cameras and a display all protected with a chassis intrusion detector prepared using the teachings of this disclosure.

FIG. 38B is a perspective view of the apparatus of FIG. 38A seen from the rear.

FIG. 39 shows use of dual call centers.

FIGS. 40A and 40B illustrate a preferred design of a monitor using a reflection display.

FIG. 41 illustrates a preferred design of a monitor using a waveguide display.

FIGS. 42A, 42B, 42C and 42D illustrate Common optical designs for see-through near-eye displays.

FIGS. 43A, 43B, 43C, 43D and 43E Illustrate a preferred design of the monitor for two eyes utilizing a single display.

### DETAILED DESCRIPTION OF THE INVENTION

1. Introduction

A primary concept of the present invention is that a student located anywhere in the world ought to be able to obtain a degree from any college or university, provided the student can prove that he or she has mastered the coursework. Proof often comes from the student passing a series of examinations. Since the student can be located anywhere in the world, it can be impractical for that student to travel to a particular place in order to take an examination.

A secondary concept of the present disclosure is to permit a classroom full of students to take a test without cheating. Consider for example, the test required for college entrance. Normally, the SAT must be taken at an approved location where the test takers can be monitored by proctors. Cheating can still occur in that situation as has been vividly pointed out in recent cheating exposé's which have dominated the news, where proctors gave out test questions prior to the exam in one case and altered exam answers in other cases. Using the system described herein, an SAT or GRE can be taken anyplace without concern that the student may be cheating. Thus, a student does not travel to an approved location, but can take the SAT from his home, or other convenient location, which can be anywhere in the world. Additionally, many colleges and universities as well as U.S. based companies require foreign-born applicants to pass an English proficiency test, the TOEFL. In order to minimize the cost of taking such a test, a student or other person can take this test anywhere with the full assurance that he or she did not cheat.

Hiring organizations do not always care where the person has acquired the expertise if they can be confident that the student has done so. As an employer, for example, a manager does not care as much whether a person graduated from Harvard or MIT as he/she does whether the prospective employee has mastered the coursework. On the other hand, having a degree listed on a person's resume can greatly affect the person's opportunities for employment throughout his or her lifetime. In the United States, however, colleges and universities have become unreasonably expensive, especially when consideration is given to the fact that for the most prestigious schools, the student usually is required to reside on or near the campus. This residency requirement has little to do with his or her mastery of physics, engineering or other scientific or non-scientific subjects, but handicaps an otherwise qualified student from job opportunities and lifetime earnings.

A student can typically learn the coursework on his or her own and in fact, studies have shown that for many students attending class is largely a waste of time. Over the Internet, a student can be exposed to the very best teachers providing well constituted lectures, textbooks and other coursework. If this is done with many students, the cost per student is minimal. What is needed, however, is a method of verifying that a student has mastered the subject matter through taking and passing examinations over the Internet or in a classroom, and without cheating and at minimal cost to the institution.

A further advantage of secure test systems described herein is that they permit standardization of courses and tests. Thus students who choose such standardized courses can study those courses from any college or university that meets the standard. A particular course, for example, may not be offered from a particular university during a particular semester and thus the student would be free to take that equivalent course from another college or university and since the tests would be standardized the credits can be honored by any university where the student eventually wishes to obtained his or her degree. Thus, degrees become more portable and their acquisition more suitable to people who may live at various locations during the time of the college or university experience.

An objective of the present invention is therefore to provide a system that can ascertain the identity of a test-taker with certainty and that cheating has not occurred during test-taking. Prior to discussing how these goals are achieved, an understanding of the cheating prevention process needs to begin with an analysis of the flow of information from the test-providing institution to the test-taker's eyes.

For now, assume that the test is a multiple-choice test or one where the answer is in the form of a number. The institution can randomize the questions and answers of a test so that no test-taker will take the same test with the same order of the questions or answers. Therefore, knowing the answers provided by one test-taker cannot help another test-taker. As a result, answers sent back to the test-provider do not need to be encrypted, except where added security is desired that the answers have not been altered by the test-providing company or the college or university as explained below.

The questions making up the test however do need to be encrypted and careful attention needs to be paid to where the decryption process occurs and to the protection of the private key which performs the decryption and the process by which it is generated. For example, if the decryption occurs in an unprotected computer, then two problems arise. First, the decrypted test can be captured, and a copy sent to a computer in another room, for example, or the private key can be copied, and a second computer can simultaneously decrypt the test. Once the test can be viewed by a consultant who is not seen by a proctoring system, the consultant can transmit answers to the test-taker by a countless number of methods facilitating cheating.

Consider how the consultant might conduct this transmission to the test-taker. Perhaps, the consultant is in an adjoining room and transmits answers using RF communication to a device hidden on the body of the test-taker which retransmits to a receiver pressed against a part of the test-taker's shoulder or head, hidden by his or her hair, or mounted on his or her teeth. Such devices are readily available. RF frequencies used can be chosen to be undetectable by any device designed to detect such transmissions since the range of frequencies available span more than 6 orders of magnitude and, in addition, frequency hopping techniques can be used. An RF sensor mounted anywhere cannot pickup such transmissions without knowing the transmitted frequency and coding scheme.

Even if the consultant is in another country, if he or she can see the test, there is no way to prevent transmission of answers to the test-taker. Other methods include vibrators in the seat, wires attached to head-mounted speakers, etc. The consultant can even project the answers onto a portion of the room ceiling, walls or floor which is not covered by room monitoring cameras but observable by the test-taker and can even alternate such locations to fool systems that monitor the test-taker's behavior. Basically, there is no method of preventing the consultant from communicating answers to the test-taker and therefore, it is necessary to prevent the consultant from obtaining a copy of the test questions.

If the questions are decrypted on an ordinary computer, then many potential information leakage problems exist. Regardless of the operating system, if the consultant can obtain access to the processor board of the computer, then the connector that connects to the display can be removed and reconnected to a splitter inserted in such a manner that the display operation is unaffected but a second set of wires are now available which contain the display information. These wires can be connected to a small processor which connects them to a transmitter to send the display information to another room by undetectable RE Alternately, a simple wire can be used, hidden from view of whatever monitoring cameras are present.

Another approach is to steal the private key which cannot be protected in an arbitrary computer. Once the consultant has the key, he or she can intercept the transmissions to the computer and decode the test in a second computer. A conclusion is that the private key, and/or the code used to generate the key, must be stored and the decryption process undertaken in a special protected device discussed below.

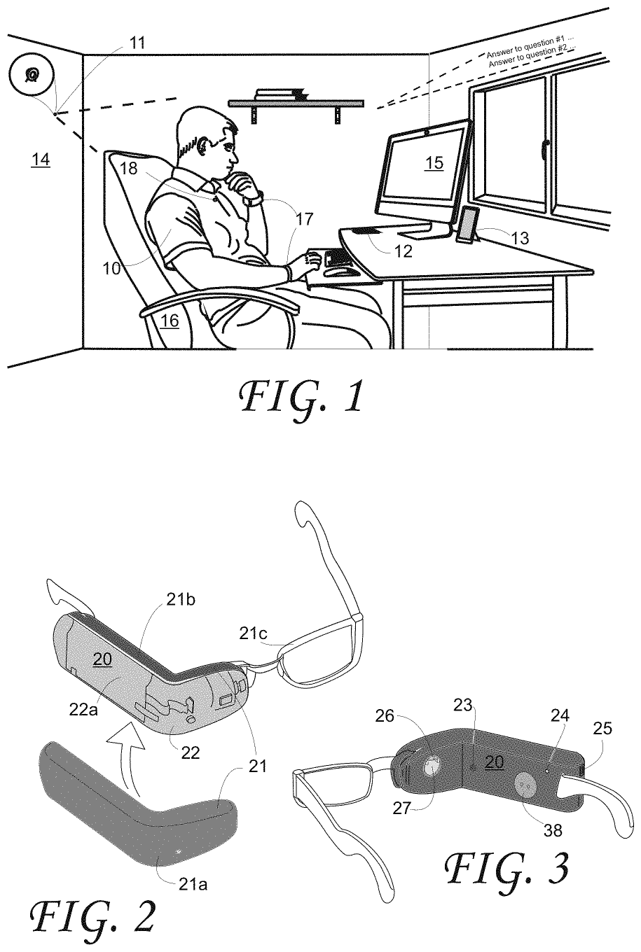

Consider now the display. If there is a display where the questions can be seen from anywhere other than the eyes of the test-taker, then there is another path for leakage of test questions. If decryption occurs right at the display and the display is protected from tampering, the display itself can facilitate transmission of the test questions. A camera looking through an undetectable port in a wall, see FIG. 1, or undetectably worn by the test-taker, can capture the image of the test questions and transmit this to a consultant by any number of methods. Thus, either the display must be scrambled, so that only the test-taker wearing special glasses can see the questions, or the display must be so close to the test-taker's eyes that no one else can get close enough to see it. The second of these approaches will be discussed below. A conclusion is that no ordinary display or ordinary computer is usable without incurring a risk of cheating.

Some methods for accomplishing the objective of cheating prevention which have been considered include using one or more cameras to image a substantial portion of the space around the test-taker so that a consultant (or other person aiding the test-taker) cannot be located in a position where he or she can influence the test-taker without being seen by a camera. A structure has been proposed such that the computer on which the test is being taken will not be accessible by another computer in another room, for example, where a consultant can simultaneously view the exam and communicate answers to the test-taker. If this structure is separated from the display and if the display is not scrambled or very close to the test-taker's eyes, this approach can be easily defeated. Also, it is not required that the consultant be where he or she can be observed by any cameras.

Similarly, it has been proposed that a microphone is preferably available to monitor the audio environment where test-taking is occurring to prevent audio communication with the test-taker by a consultant. A microphone will not pick up communications from the consultant in the form of RF communications translated into sound at the head, for example. The microphone will pick up any oral communications from the test-taker and thus it can be a necessary part of the system to detect if the test-taker is orally reading the questions to a consultant. To make sure that the microphone has been activated, a speaker or other sound source may be necessary to periodically create a sound which can be sensed by the microphone. Otherwise, the test-taker can cover the microphone or otherwise render it useless. An alternative or complementary approach, as described below, can make use of a contact microphone pressed against the skin or a facial bone, e.g., cheek bone, of the test-taker which will pick up sound emanating from the mouth of the test-taker but not be heard by the audio microphone. An audio microphone detects sound from the environment in addition to that from the test-taker. These sounds can drown out or otherwise prevent the microphone from picking up the test-taker from softly speaking into a hidden microphone that communicates with a remote consultant. These and other methods and apparatus are discussed below but already it has become evident that the apparatus used to take the test must be especially designed to solve the issues mentioned above.

The identity of the test-taker must be known and can be ascertained using one or more of a variety of biometric sensors and systems such as a palm, fingerprint, heartbeat shape, iris, retinal or other scan, a voiceprint, or a good image of the test-taker coupled with facial recognition as further discussed below. For the purposes of the present invention, the primary biometric identification system will rely on the use of a small camera which has been designed to periodically image the test-taker's iris, retina or portion of the test-taker's face as discussed below.

When taking a test, the test-taker can go through a process which sets up the apparatus and validates its operation. The test-taker can then confirm his identity which will have been previously established and stored locally or remotely for comparison. The process of ascertaining the identity can be recorded for later validation. Output from the various monitoring systems can be fed to one or more pattern recognition systems, such as trained neural networks, which have demonstrated a high accuracy.

Each time the student takes one or more tests and thus demonstrates his or her mastery of the coursework (by passing), he or she can be awarded credits and after sufficient credits have been obtained, he or she can be awarded a degree. After the degree award, the student would then presumably begin working for a company, government agency, or other organization and the system should periodically be verified through consultations or surveys with the management of the organization to ascertain that the hiring organization is satisfied with the proficiency of the student derived from the online courses. This feedback allows for continuous improvement of the overall educational and testing process and system.

The degree-granting institution will incur costs during this process and some payment from the student to the institution may be considered. Depending on the circumstances, this payment can be a charge per course, per test or per degree. Since the earning power of the student can be significantly increased, and out-of-pocket cost to the institution is small, these payments can be postponed until the student is being paid by a hiring organization and, in fact, such an organization may be willing to cover these payments. In any event, the payment should be relatively small when compared to the typical cost of a traditional college education. However, the degree-granting institution by this method, can greatly expand the number of degrees granted and thus, although the payment per student will be small, the total sum earned by the institution can be substantial.

A good review of the state of higher education in the United States and of the rise of MOOCs can be found in the Nicholas Can's article on the subject as published in the MIT technology review. The article can be found on the following Internet website. http://www.technologyreview.com/featuredstory/429376/the-crisis-in-higher-education/. Quoting from this article “Machine learning may, for instance, pave the way for an automated system to detect cheating in online classes, a challenge that is becoming more pressing as universities consider granting certificates or even credits to students who complete MOOCs.” It is an objective of this invention to respond to the mentioned challenge.

As discussed in numerous places in the literature, there is a significant difference in the complexity of evaluating a student's proficiency through tests which can be machine graded depending on the course subject matter. For those math and science courses where a numerical answer is to be derived, machine evaluation of the test is relatively simple. However, for those disciplines where a reasoning or writing skill or an artistic or mechanical skill is evaluated, there is great controversy as to whether this can be done by machine testing. This issue will not be addressed here other than to note that more research and innovation in this area is necessary.

It is not an objective of this invention to determine how a test should measure a student's proficiency nor how it should be graded. A primary objective here is to provide confidence to the degree-granting institution that the student who is taking a test is in fact the student who has registered for the course and that the student is acting alone without the aid of a consultant who may be remote or nearby. This assurance should be provided with a probability of cheating reduced to on the order of one in 100,000 and, similarly, the false accusation that cheating is taking place reduced to a similar probability.

When a student decides to enroll in a degree program, for example, or even to enroll in a course for which he or she desires credit, the first step will generally be to register with the organization, typically a college or university, and to establish the beginning of the student's record. During this registration process, for the case where the student intends to get credit for one or more courses taken online, the student will be required to submit various types of information which will permit the student to be identified positively over the Internet. Although generally there may be no charge for taking the course, there will generally be some charges related to the test-taking and administration of the student's program. In a preferred embodiment of this invention, a specially configured device will be loaned or sold to the student to be used primarily for test-taking.

When the student registers at a school, he or she will be generally required to submit a picture that will become part of his or her record. Later, when taking a test for the first time using the monitor, another picture may be required so that the student can be properly associated with the public key, derived from his or her iris code, which will be part of his student ID. A second picture of the student may be required on registration while wearing the monitor. This is as a second check that the student in the school picture is the one wearing the monitor when the iris-based public key ID was created. In fact, to assure the maximum integrity, every person that registers with a college can be required to provide a picture which will be linked with his or her iris code and thus to his or her transcript. A student with the wrong iris code would then not have his transcript updated. Also, a prospective employer who receives a transcript also gets a picture which should match the person being interviewed or hired. If the registration is done online, the laptop webcam can be used. If a student cheats by having a consultant take his or her tests, the transcript will not match the proper iris code and either the transcript will not be updated or the transcript picture will not match the person.

Wearable glasses which satisfy objects of this invention are described below and are configured so that all the functions necessary to identify the student and significantly reduce the opportunity for cheating are incorporated within the glasses design, hereinafter called the “Monitor”. At the end of the course, or when the student completes his relationship with the institution, he or she may be required to return the Monitor; however since in some implementations the Monitor may be linked to the student's biometric-based identification, the biometrics stored on the device, if any, would need to be erased or overwritten by those of another student (described below). In one method, a cryptographic key set used for decrypting a test is created based on one or more biometric measurements each time the student puts on the Monitor. In this case, one Monitor can be used for any number of students and a student can use any Monitor. In this case, the student's biometrics, or data derived therefrom, can only be stored on the Monitor while it is in use by the student and erased when the student removes the Monitor. This also removes biometric privacy concerns. In some implementations, due to the cost and computational complexity of the software, the biometric, such as the iris scan, can be sent to an internet server and converted into a unique code which is then returned to the Monitor. In this latter case, the iris image can be erased from the server.

Since the value of a degree from a prestigious institution can be immense, the motivation to cheat when taking a test can be enormous. One can foresee, for example, an industry of consultants developing solely for aiding students in taking tests and thus obtaining a degree. The system of this invention is therefore configured to minimize the possibility of success of such consultants.

If a student, when taking a test, is inclined to cheat, this inclination can be facilitated if a helper or consultant has access to the display which shows the test while it is being taken. If the consultant has such access, then he or she will use a communication method by which he or she can transfer information to the test-taking student in a manner that cannot be detected. This invention is intended to reduce and ideally eliminate the opportunity of the consultant from observing the display or otherwise learning the content of the test questions and therefore of being able to derive and communicate answers to the test-taker.

If the student were to use his or her private computer for displaying a test, it would be generally relatively easy for a consultant to attach a second remote monitor which would display the same information as the primary monitor. There exists software, for example, which permits someone who is even located remotely from a particular computer to observe the display of that computer. Alternatively, if the student or his consultant has access to the ports and operating system of the computer upon which the student takes tests, access to the information on the display is relatively simple to achieve. One method of preventing this is to design a device which prevents other computers from connecting with the device in such a manner that the display can be copied. Thus, in a preferred implementation of the invention, it will be assumed that a special device, and in particular a wearable glasses type device, herein called the Monitor, has been configured and provided to the student for those cases where the student desires credit for the course he or she is taking.

2. Basic Monitor Embodiment

FIG. 1 illustrates a student 10 taking an examination using any one of various proctoring systems such as Examine or Proctor U. The student 10 can get help when answering examination questions if the consultant has access to these questions. This can be accomplished in many ways such as through a hidden camera 11 which can be embedded in a wall 14 facing a computer screen 15 used for administering the test, hidden on the student 10 and looking through a hole in the student's shirt 18 or embedded in a piece of jewelry 17, or, most easily, a transmitter can be built into the computer which transmits the contents of the display to the consultant in another room. The consultant can be a person who already knows the material being tested or he or she can query the internet for the answer.

Since the consultant can see the questions, there are countless ways that answers can be communicated to the student 10 such as by projecting them on the floor, a wall or ceiling, placing a bone speaker in the student's seat 16 where it will contact the student's spine or on his/her shoulder under his/her clothes, for example, or even tying a string around the toe of the student 10 and pulling three times for answer c. Broadcasting answers can be provided by smartphone 12 or tablet 13 behind the computer monitor 15. None of these methods, and countless others, can be detected by an online proctor. It is thus not possible to prevent a consultant from communicating with the test-taker, leaving the only remedy left of preventing the consultant from knowing the test questions.

Of course, other methods are available such as bribing the proctor or someone that can provide a copy in advance of the test questions and answers. Prevention of these methods will be discussed below. Since cheating is easily accomplished using all known proctoring or other anti-cheating methods, there is an urgent need for a system that cannot be defeated. Until that is available, granting of meaningful credit for online education is not possible.

A device constructed in accordance with teachings of this invention is illustrated in FIGS. 2 and 3 which are perspective views of a head-worn glasses type device, generally referred to as a monitor 20, containing an electronics assembly (PCB) 22a with several sensors, cameras and a display all protected with a chassis intrusion detector 22 (CID) prepared using teachings herein.

FIGS. 2 and 3 are views from the front and rear respectively showing the device or monitor 20 which comprises three main parts: plastic housing parts 21a and 21b (collectively referred to as a housing 21) and internal PCB parts covered by chassis intrusion detector 22 (CID). Housing part 21a serves as a cover. Housing part 21b extends from an eyeglass frame 21c. Housing part 21b can be substantially L-shaped with a first portion extending straight outward from an edge of the frame 21c and second portion substantially perpendicular to the first portion and positioned in front of the frame 21c. The frame 21c has a lens portion including an aperture for receiving an optional see-through lens (prescription or plain glass) and a support portion extending rearward from the lens portion. The support portion may be two temples as shown, or an elastic headband as described below.

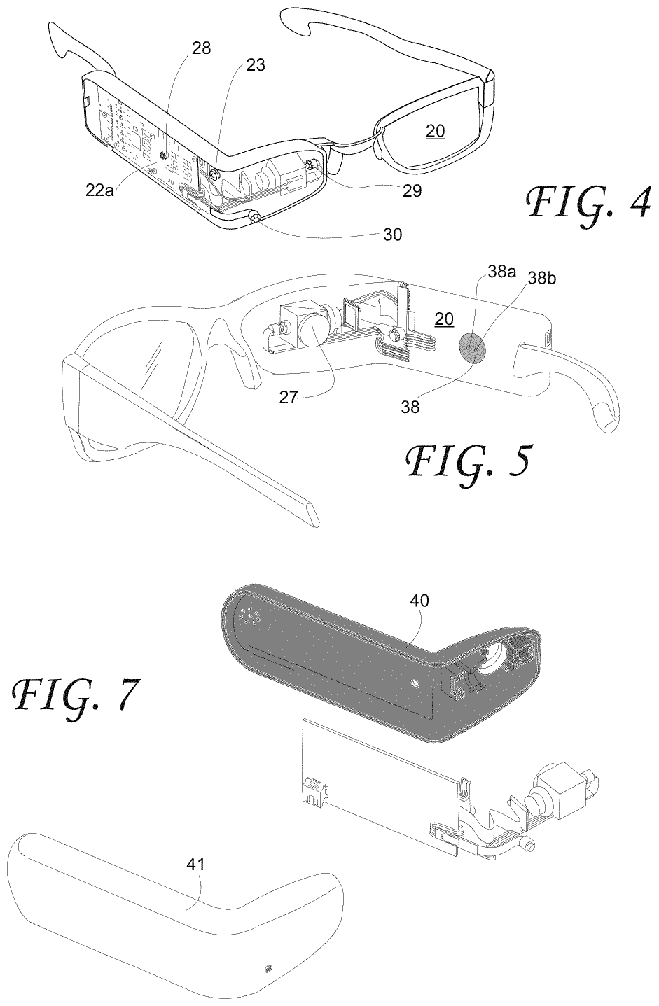

FIGS. 4 and 5 are perspective views of monitor 20 looking from the front and rear respectively showing a cross-view camera 23, a display 27, a contact microphone 38, and a microphone 28. A wire from the PCB 22a comprises, e.g., four flat conductors and passes though the CID 22. A USB plug 25 is built in a way that it snaps into the housing 21. Plug 25 is located outside of the CID 22. Also illustrated are the contact microphone 38 with embedded contact sensor, which can be a skin temperature sensor (thermocouple), pulse from blood flow sensor (as in a pulse oximeter), or part of an EKG sensor. An EKG sensor requires at least two sensors displaced from each other in order to get a measurement of the heart pulse shape. Only one is shown in FIG. 5. Also shown are the positions of the cross-view camera 23, microphone 24, iris camera 29, forward-looking camera 30, where monitor plastic housing part 21a and CID 22 (from FIG. 2) have been removed.

FIGS. 4 and 5 illustrate monitor cutaway drawings showing the internal design of the device. Display 27 is arranged in the housing part 21b and pointed toward the right eye of test-taker and displays test questions during a test (although alternatively, a display can be pointed toward the left eye of the test-taker). Forward viewing camera 30, representative of an imaging device, is also arranged in the housing part 21b and monitors the field of view (FOV) of the test-taker outward from the monitor 20. Camera 30 can have a field of view of approximately 120°, alternatively 2 cameras having individually a smaller FOV can be used. Buzzer or sound creator 28 is arranged in the housing part 21b and periodically provides a sound detectable by the microphone 24 to verify that the microphone 24 has not somehow been rendered inoperable. Microphone 24 and buzzer 28, or alternately a speaker, are on the PCB 22a and thus aligning holes are located on the side of the housing 21.

Display 27 is arranged at a terminal end of the second housing part 21b. The forward viewing camera 30, or other imaging device, the microphone 24 and the buzzer 28 are also arranged on the side of the second housing part 21b (see FIG. 4). Each of these components is connected to a processor-containing electronics package in housing 21 which is mounted to the frame 21c in a manner known to those skilled in the art to which this invention pertains. A cable emanates from the electronics package in housing 21 and can contain or be terminated by the USB connector 25 for connecting onto an external device such as a power and communications module, smartphone or computer.

The iris, or retinal scan, camera 26, is arranged in housing 21, pointing inward toward the wearer, and measures biometrics of the test-taker (see FIG. 3). Such biometrics can include an iris or retinal image, image of the blood vessels in the white portion of the eye or an image of the portion of the face surrounding and including the eye. Illumination of the eye can be provided by LEDs arranged in the housing 21 which can be in the IR or visible portions of the electromagnetic spectrum. Iris camera 26 is therefore more generally considered a biometric scan camera.

Software and a processor which controls test administration can be resident on an external server of the test-provider and operates in conjunction with the electronics package in housing 21. Communication to and from this external server can be via the Internet.

Camera 23 can also be provided in housing 21 to check for any anomalous activity which might take place near the glasses (see FIG. 3). Such a camera 23 can enable detection of whether an image capture device has been either temporarily or permanently affixed to the monitor 20 or to the face of the test-taker which can capture the image on the display 27. Similarly, camera 23 can monitor the space surrounding the left eye of the test-taker to assure that such an image capturing device and or another display for providing aid to the test-taker is not being employed by the test-taker in conjunction with his left eye. This is achieved by processing images obtained by the camera 23 using an image processing algorithm to determine the presence of another image capture device or display, e.g., image comparison or more generally image analysis. The camera 23, or more generally an imaging device, is arranged on the first housing part 21a and oriented to image most of the frame 21c (see FIG. 3).

To further discourage cheating, if the test-providing institution is providing tests to 1000 test-takers either simultaneously or at different times, and if the test is of a multiple-choice type and contains fifty questions, the order of the questions and of the answer selections can be scrambled and thus different for each test provided. Since this provides a very large number of different tests each containing the same questions, there is little risk that answers from one set of questions can be of any value to a test-taker taking a different ordered set of the same questions.

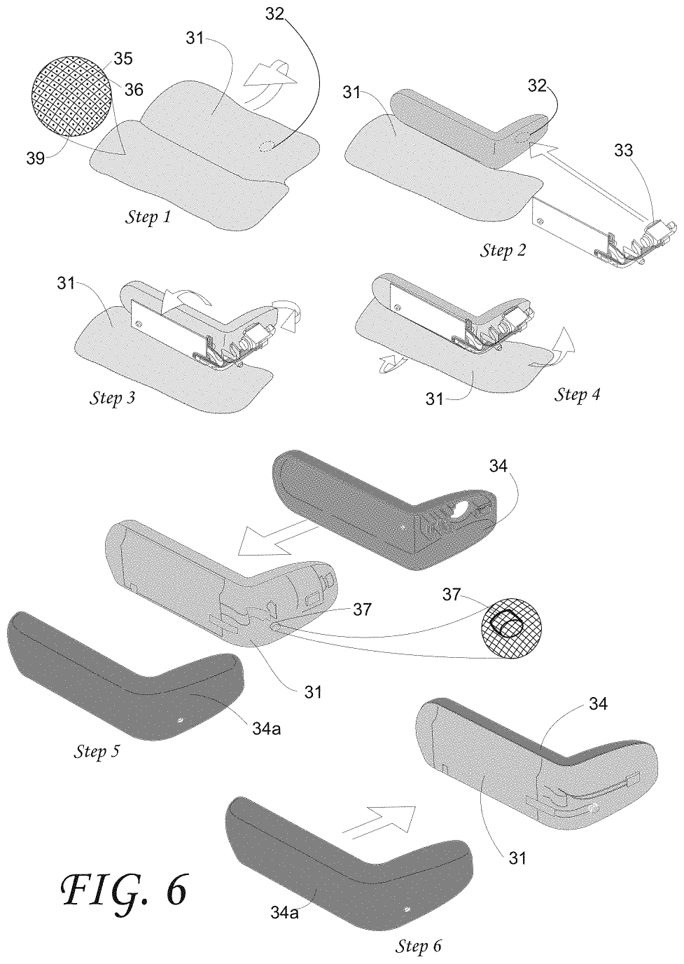

The entire electronics package of the device 20 (FIGS. 2-5) is encapsulated in a thin film 31 (FIG. 6) called a chassis intrusion detector (CID). As described below, an array of wires can be printed onto a plastic film encapsulating the electronics package, including the display and cameras, in housing 21 such that any attempt to break into the housing 21 will sever one or more of the wires.

A private key, or the code for generating such a key as explained in more detail below, for decoding the test questions and any other commands sent by the test-providing institution can be held in volatile RAM memory in, for example, housing 21. This can be kept alive through an extended life (10 years) battery which also can be recharged when the monitor 20 is connected to a power supply (not shown) through connector 25. If the chassis intrusion detector 22 detects an attempt to break into the housing 21, then power to the RAM memory can be shut off and the private key and any other private information or algorithms will be erased. Other techniques to disable the operability of the monitor 20 for a test as a result of the detected attempt to break into the housing 21 are also possible, either alternative or additional to the erasure of the private key.

When the test-taker is preparing to take a test, he or she will place the monitor 20 onto his or her head. An image will be acquired of the iris, retina, or other biometrics by each camera 26 and sent to a server via a telecommunications network and/or the Internet. The server will convert the iris image to a code and return the code to the monitor. Using a secret and proprietary algorithm resident in the monitor (particulars of which are readily derivable by those skilled in the field of secure communications and data transmission, an example of which is provided below), the monitor can convert the code from the server to a cryptographic key set and return the public key to the server. The server will then associate and store the public key with the student's ID. At the completion of this process, test questions will be transmitted to the monitor 20 encrypted with the student's public key, decrypted by the monitor using the student's private key and displayed on the display 27, for example, one at a time.

The private key development algorithm can be held in the CID volatile ROM memory and placed thereon during monitor manufacture after the CID has covered the electronics, display and sensors of the monitor. This algorithm is erased if power is lost to the ROM memory such as will happen if a wire making up the CID is cut as entry is attempted. The algorithm can comprise any of many functions which are known to those skilled in the art which can create a unique cryptographic key set based on an iris code in a manner which cannot be duplicated without knowledge of the algorithm. The algorithm is kept secure by the monitor supplier and is only released in conjunction with manufacture of a monitor. Once on a monitor, the algorithm cannot be retrieved and any attempt to do so will cause it to be erased. Thus, the key generation algorithm cannot be duplicated on any other device.

The iris camera 26 is controlled to periodically check to ascertain that the test-taker's iris is present and that it has not changed. This is controlled by the processor on PCB 22a in the monitor 20. If anything anomalous occurs, such as the absence of an iris or eyeball or the change of position of the iris or eyeball, then the display 27 will be deactivated by the processor. Thus, when the test-taker removes the monitor 20, the display 27 will automatically stop displaying test questions. Similarly, if the test-taker transfers the monitor 20 to another person whose iris does not match that of the test-taker, then the display 27 will not show test questions. Above and in what follows, the iris will be used to represent any of the aforementioned biometric scans observable by camera 26.

When the test-taker has completed answering the test questions, he or she can indicate such through the mouse or keyboard (user interface) and the display 27 will no longer display test questions. The remainder of the interaction with the test-providing facility can then occur as described below.

Forward-looking camera 30 can have a field of view (FOV) of about 120° or, alternatively, more than one camera each with a lesser FOV view can be provided. This FOV will cover the hands of the test-taker to check for the case where the test-taker is typing in the questions on a keyboard to be subsequently transmitted to a consultant. If the hands of the test-taker cannot be seen by camera 30, i.e., are not present in images obtained by the camera 30, the display 27 will be turned off until the hands can be seen. If this happens frequently, the test can be terminated. Camera 30 can also be used to check for the existence of other devices near the test-taker. These devices may include a tablet or other computer, a smart phone, books or papers, displays, or any other information source, including notes projected onto the ceiling, wall or floor, which is not permitted to be used for the particular test. If the test is an open book test, then use of some of the above-listed objects can be permitted. Software which accomplishes these pattern recognition tasks can utilize one or more trained neural networks.

The test-taker may have enabled a hidden switch which disconnects the keyboard when a keyboard is allowed, from the monitor 20 and connects it to a consultant thereby enabling the test-taker to send test information to the consultant. Camera 30 can determine that the test-taker is typing and the processor can ascertain that the monitor 20 is not receiving the typed information and indicate a fault. For most tests, a keyboard will not be necessary and thus it can be eliminated from the setup to minimize its use for consultant communication.

A limited number of encrypted commands relating to the test being administered can be transmitted with the encrypted test from the test-providing institution or test-administrating facility. These commands control some aspects of the test-taking process such as whether it is an open book or closed book examination, whether it is a timed test and if so how much time is allowed, how many restarts are permitted, how many pauses are permitted etc. Since the test process is controlled by the monitor 20, these commands will be decrypted and used to guide the test-taking process by the monitor 20.

Camera 30 similarly can be used to check for anomalies near monitor 20. Again, the pattern recognition software used with camera 30 can utilize one or more trained neural networks. Camera 26 can check for small cameras which may have been glued to the face of the test-taker, for example, by comparing images and/or using pattern recognition via a processor, and that can capture a view of the image displayed on display 27. Also, the FOV of the display 27 can be limited so that only the area near the eye of the test-taker can see the display 27. Thus, to see and capture the display 27, a camera will need to be near the path from the display 27 to the eye. Furthermore, the design of the monitor 20 can be such as to minimize the available structure which would permit installation of a hidden camera.

Contact microphone 38 can snap onto the housing 21 and be located on the inward side of the housing 21 so that it is in direct contact with that portion of the housing 21 alongside one of the temples. At this location, it can be pushed against the cheek of the wearer when the wearer is wearing the monitor 20. In this non-limiting configuration, contact microphone 38 can contact the wearer's face, for example, along a portion of the housing 21 at the cheek or other portion of the face. The function of the contact microphone 38 is to detect any vibrations such as are caused by talking or even whispering by the test-taker, or generally any sounds being emitted by the test-taker which necessarily result in vibrations of the bone and/or skin. These vibrations are detected as a result of contact of the contact microphone 38 with the skin of the wearer, and ideally when pressed against a facial bone of the wearer. The functionality of the contact microphone 38 may be incorporated into another component that would also be considered equivalent to a contact microphone, namely, any component that is able to sense or detect vibrations through contact with skin or another body part which vibrates whenever the test-taker is talking or making other oral sounds. As explained below, a contact speaker can also be provided to check that the contact microphone is against the face of the test-taker.

Housing 21 can also have two holes, or groups of holes, one for a small LED 38a and the other for a small photocell 38b (see FIG. 5). Each hole can be about 2 mm or less in diameter. They may be placed in the center of the contact microphone 38 and holes can be drilled through the microphone 38 for the wires from the photocell 38b and LED 38a to travel to the PCB 22a. An alternative is to replace the LED 38a and photocell 38b with a thermocouple or thermistor which measures the skin temperature of the test-taker. In either case, the purpose is to ascertain that the contact microphone 38 is pressed against the face when the monitor 20 is worn by the test-taker so that it will sense any sounds coming from the mouth of the test-taker, that is, to determine contact between the contact microphone 38 and the skin of the wearer.

Generally, there should be no talking while test-taking is in progress. Microphone 24 is used to detect audio sounds and spoken words. If such words are detected particularly emanating from the test-taker, then a responsive action to halt the display of test questions can be undertaken, for example, the test can be paused or terminated depending on the test-providing institution's requirements.

To prevent the microphone 24 from being covered with sound absorbing material, a speaker, or other sound creator 28 is provided to periodically create a sound which is detected by the microphone 24 and the quality of the detected signal can be ascertained. If the microphone 24 cannot clearly hear the sound produced by the sound creator 28, then the test can be terminated until the issue is resolved. Sound creator 28 may be placed at an alternate location on the housing 21 or frame 21c to minimize direct sonic conduction through the structure. As described below, the speaker can be incorporated into the contact speaker used to check the contact microphone.

3. Chassis Intrusion Detector

A schematic of the operation of the chassis intrusion detector 22 is provided in FIG. 6. Since the chassis intrusion detector 22 is designed to encompass the entire electronics and sensors assembly, it must be relatively thin so as not to interfere with the contact microphone 38, microphone 24 and speaker or sound creator 28 and be transparent such as to not interfere with the display 27 or camera 26.

The CID 22 is a thin film which wraps around the PCB 22a and other parts. It can be made from a single sheet folded over and then glued together. It must conform closely to the camera 26 and display lenses so as not to distort the images obtained by the camera 26. A wire to the USB connector 25 will be very thin where it goes through the CID 22. Connector 25 can snap into a holder built into the housing 21.

A preferred construction, as illustrated in FIG. 6, is to provide a single film layer (base film 31) comprising a labyrinth of wires 35, 36 which are very narrow and closely spaced such that any attempt to penetrate the film 31 will cause one or more of these wires 35, 36 to be cut. The base film 31 can be made from polyimide onto which is printed the electric wires 35, 36. The final assembly is covered with a thin coating to insulate the wires 35, 36. A microprocessor (not shown) monitors the total resistance, inductance and/or mutual inductance of a circuit including the wires 35, 36 and erases the private information if there is a significant change in these measurements, e.g., above a threshold. Since any attempt to break into the electronic and sensor assembly will necessarily sever one of these wires 35, 36, this design provides an easily detectable method of determining an attempt to intrude into the system electronics and sensor assembly.

CID 22 has following properties:

1. The wires 35, 36 can go along both sides (FIG. 6). They can be run one way on one side and cross at right angles on the other side. Alternately, wires can be printed only on one side of the film.

2. The wires 35, 36 on one side will be connected to those on the other side by plated through holes so that there is one continuous circuit.

3. On the underside near the mating socket in the PCB 22a, the wires 35, 36 will get wider (about 200 microns) so that a 2-pin connector can be attached.

4. The CID 22 can have very small holes 39 (about 50 to about 100 microns diameter) located in the centers between the wires 35, 36, or alongside of wires when only one side has wires, to allow it to breathe to prevent the buildup of heat from the electronics.

Assembly procedure may comprise the following steps (FIG. 6):

Step 1: prepare to wrap film 31 constituting the CID 22 around PCB 22a.

Step 2: wrap CID 22 over the PCB 22a. A critical step here is the attachment of the CID 22 to a display lens 33. Circle 32 is a marked location on the CID 22 opposite the position of display lens 33. Circle 32 will be glued to the display lens 33.

Steps 3, 4: after gluing the PCB assembly, plug the CID 22 into the PCB 22a and wrap the rest of CID 22. Now, the PCB 22a is fully covered by the film 31 to form the CID 22.

Step 5: insert PCB 22 in housing 34; forward looking camera 37 and cross view camera are covered by the film 31 of the CID 22.

Step 6: Snap housing part 34a (like housing part 21a) into the housing 34 (like housing part 21b).

FIG. 7 shows the unassembled device housing: rear housing part 40 and front housing part 41 which are similar to housing parts 21b, 21a, respectively.

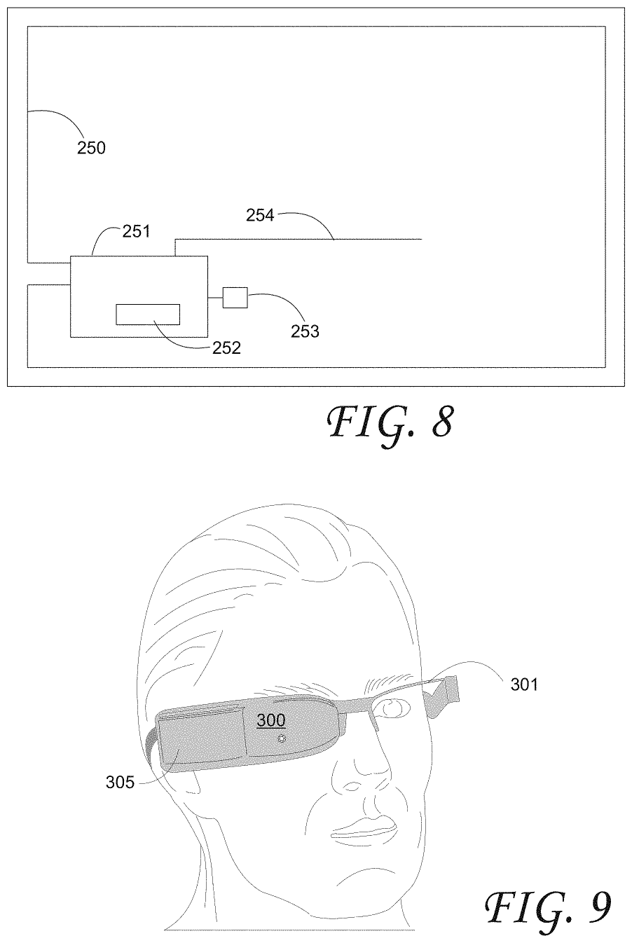

FIG. 8 illustrates that the chassis intrusion detector (CID) can contain its own microprocessor security assembly 251, containing the circuit property monitoring processor, and battery 253, or they can be located on the PCB 22a. The CID 22 can also contain its own RAM memory 252. The RAM memory 252 can contain the private key and/or key generating code and other private information which is kept alive and thus usable by the battery 253. The battery 253 is chosen such that it can provide sufficient power to maintain the RAM memory 252 active for several years and also provide power to the microprocessor security assembly 251 to monitor the wire labyrinth. The conductive wire is attached to the microprocessor which checks, for example, the impedance of the wire. Any change in impedance detected by the microprocessor is indicative of an attempt to intrude into the interior of the electronics and sensors assembly. If such intrusion is detected, power is removed from the RAM memory 252 and the private information is erased.

A schematic of the chassis intrusion detector is shown in FIG. 8. Power is supplied from an external computer though connection 254 leading to the USB connector 25 of FIG. 3. Connection wire 254 also provides communication from the electronics and sensors assembly of which the security assembly is a part. The fine wire maze is shown at 250, the security assembly (SA) at 251, the long life battery at 253 and the RAM memory at 252. Security assembly (SA) 251 can be a separate subassembly which is further protected by being potted with a material such that any attempt to obtain access to the wires connecting the battery 253 to the microprocessor therein or to the RAM memory 252 would be broken during such an attempt. This is a secondary precaution since penetration to the SA 251 should not be possible without destroying the private information.

To summarize, any disruption of the mesh wires in the film will destroy the private key or key generating code and other private information making it impossible to decode the test questions. After the assembly of the device 20 is completed, the microprocessor can be powered on and the first step can be to measure the inductance, resistance, and capacitance, as appropriate, of the mesh of wires 35, 36. If any of these measurements significantly change, for example above or below a threshold, the circuit in the SA 251 would remove power from the RAM memory 252 thereby destroying the private information. Since the private information cannot be reloaded, the assembly would need to be returned to the factory for remanufacture and the insertion of a new SA 251 or entire electronics and sensors assembly or other remanufacturing step or process.

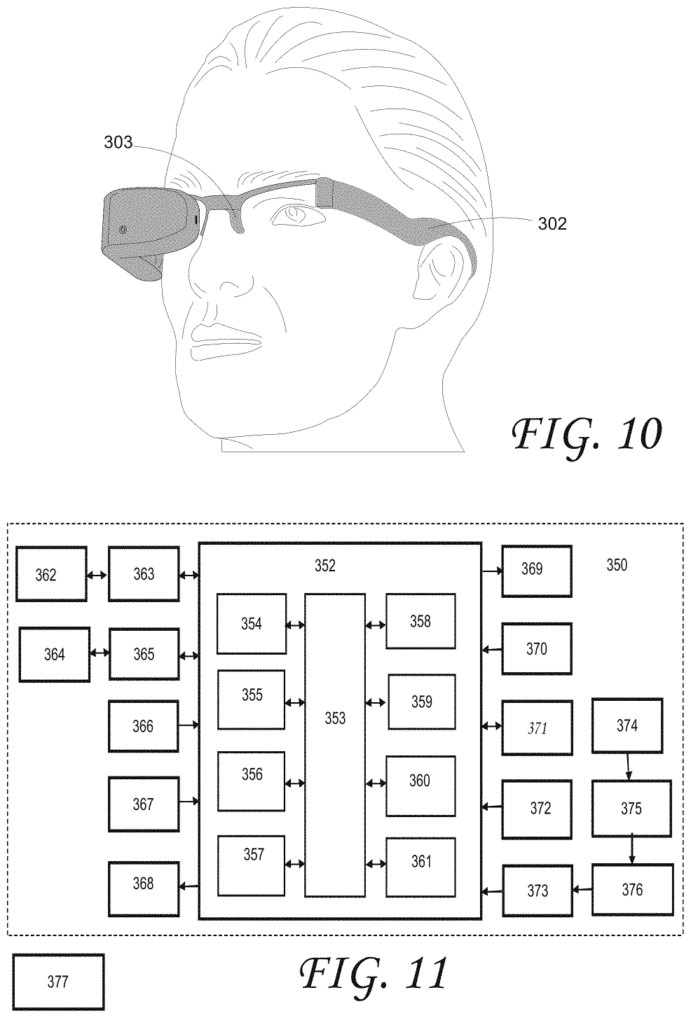

FIGS. 9 and 10 show another version of a monitor, device 300 with a frame 301 on the person without lenses. A USB connector may snap into a housing 305 before the housing 305 is closed. A variant of the nose pad 303 and temple 302 are shown in FIG. 10.

4. Administration and System Operation

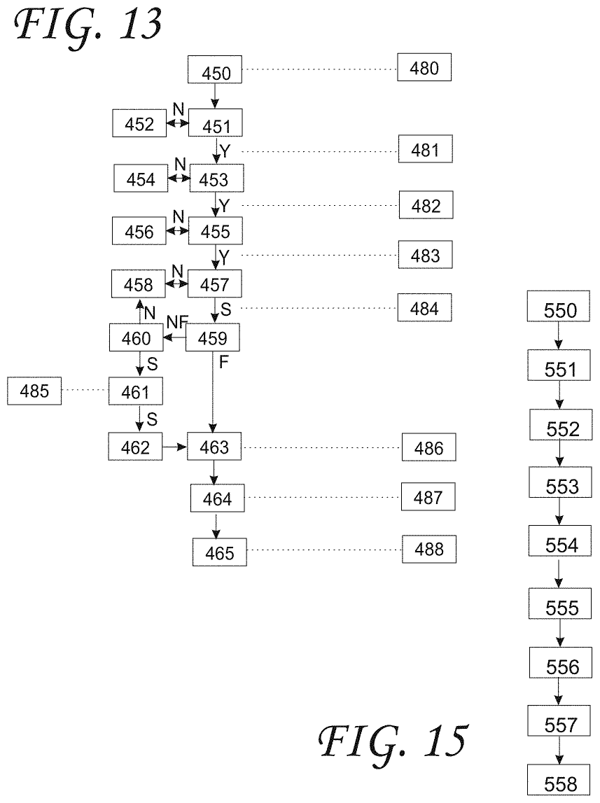

A representative device block diagram is illustrated in FIG. 11 which is generally applicable for devices and monitors disclosed herein. The device is represented generally as 350 and typically comprises a (micro)processor generally at 352 which further can comprise a CPU 353, a display interface 354, an iris camera interface 355, a forward view camera interface 356, a cross view camera interface 357, an eMMC 358, RAM 359, a communication interface 360, a LED control interface 361, a display optical interface 362. Also in the device 350, there can be a display 363, an iris camera optical interface 364, an iris camera 365, a forward view camera 366, a cross view camera 367, a iris camera LED 368, a buzzer or other sound maker 369, an audio and/or contact microphone 370, a Wi-Fi module 371, a mouse/keyboard interface (Bluetooth) 372, a battery 373, a CID battery and mesh 374, a CID controller 375, a data and charger interface 376 and an optional external camera Wi-Fi interface 377.

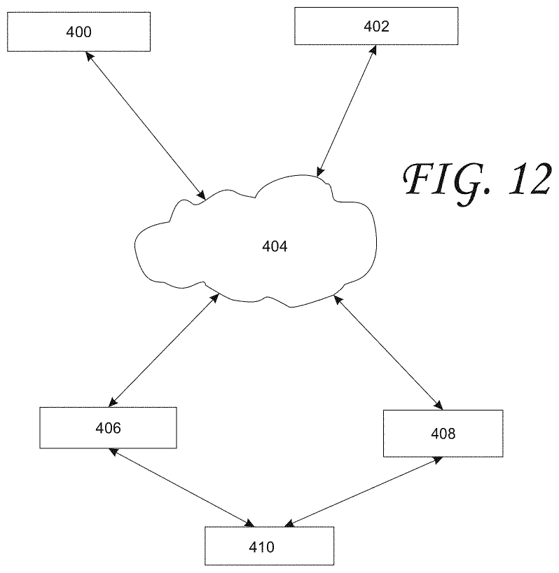

A system block diagram is shown in FIG. 12 and comprises a server 400, a Test-Provider or test-providing institution or test-administrating institution 402, a communications network 404, one or more monitors or devices 406, a computer 408 and the user 410.

An administrator flow chart is illustrated in FIG. 13 and can comprise the following steps, not all are required:
450 User plugs in monitor
451 Mouse connects
452 Mouse setup
453 Wi-Fi connects
454 Wi-Fi setup
455 Iris scan
456 Wait
457 Web call
458 Troubleshoot
459 Get name
460 Web call
461 Send iris digital image and Monitor/Device ID
   Server returns iris code to Monitor/Device
   Monitor/Device creates cryptographic key set based on iris code and proprietary algorithm
   Monitor/Device sends public key to server
462 Iris, Monitor/Device codes and user public key linked with user and added to list on server
463 Test-taker authenticated
464 Choose test to take
465 Proceed to test-taking sequence
480 Display “Power is on”
481 Display “Mouse connected”
482 Display “Wi-Fi connected”
483 Display “Iris scanned”
484 Display “web call successful”
485 Display random number e.g. “234 342 907 enter using login computer”
486 Display “Welcome Ann Smith”
487 Display list of user's available tests
488 End of login sequence

When this is accomplished, a signal can be sent to the server indicating that the test-taker is ready to take the examination. Note that an alternative would be for the iris code to be created on the Monitor which eliminates the need to send the iris image to the server. This increases the computational requirements of the Monitor-resident processor but eliminates any concern that the iris biometric image is stored by the server.

The proposed running sequence is as follows:

1. A student places the Monitor on his head, establishes a WiFi connection and, using the mouse, initiates acquisition of his iris image.

2. The iris image is transferred to the test management and supplying server, hereinafter called AOE server, where it is used to create the iris code using standard software.

3. The iris code is sent back to the Monitor

4. The Monitor, using a secret or proprietary software algorithm, creates the AOE student ID and cryptographic key set from the iris code.

5. If this is the first initiation, the student enters his university student ID which is sent to the AOE server

6. The Monitor sends the Monitor ID, the student ID and public key (which can be the same as the Monitor ID) to the AOE server.

7. The AOE server validates that this is a registered student.

8. Later, for software updates, new software can be loaded over WiFi from the AOE server whenever desired using the student's public key. Once the sequence above is completed, the AOE server sends a code indicating that a software update will follow

What is generally not realized is that teachers and administrators play a significant role in cheating. Alleged cheating behaviors include the following and how it is avoided using the Monitor based test system described herein:

1. Changing students' answers after the test. When the test is completed, the answers can be first encrypted using the AOE public key and then again using the school's public key. The AOE server will generally grade the test and forward the test grade to the school. If there is any doubt as to whether the answers were changed, the two encrypted copies of the test answers can be compared.

2. Teaching to the test. A significant number of potential test questions can be generated based on the subject matter to be tested. When a particular test is to be given to a class, questions can be chosen at random from this much larger list. Therefore, the teacher cannot teach to the test since no one will know ahead of time what questions will be on the test period 3. Illegal coaching during a test. Since each student taking the test will have a different test and conversation between the test-taker and any other person will be captured, it is not possible to coach the test-taker during the test.

4. Using live exams as practice exams. Generally the instructor should not know what the test questions will be and therefore they cannot be used as practice exams.

5. Reading off answers during a test. Since the instructor will not know the test questions and each test-taker will have the questions presented in a different order, also since any audio conversation can be monitored and recorded, it is not possible to read off the answers to the test during the test period

6. Providing extra time for tests where there is a time limit. This can be made part of the control system of the monitor. In other words, each test will be allowed a certain amount of time. Extra time therefore cannot be allocated without that fact being known.

7. Disallowing low-achieving students from testing. A low-achieving student will not be able to get credit for the course unless he or she has successfully passed various examinations.

Generally, the tests administered by the Monitor will be closed book tests in which case, the forward-looking camera should not see any books, notes, laptop computers, cell phones, etc. that could be used by the test-taker to get the help of a consultant. In a later implementation of the monitor described below, limited access to the Internet can be allowed using the monitor. For that situation, the monitor will have a very large display including multiple screens and access to a particular website, for example, can be provided and the information that is on that website can be controlled such as to include all of the relevant information needed to answer a test question without simultaneously giving access to a consultant. The student can be permitted to add notes and other information to the website.

If cheating is detected while a student is taking a test, the student can be warned that cheating has been detected and that if it is not stopped the test will be terminated. In the rare case where they test was terminated due to an error in the cheating detection algorithms, the student can be given the opportunity to retake the test which can involve questions in a different order and even different questions.

Note that the student's private key is never transferred off the monitor. Thus if the encrypted test is intercepted, it cannot be decrypted.

One long-term goal for the Monitor is to be the vehicle where students learn as well as take tests as explained below. As such, the monitor should facilitate reading and marking of text, viewing lectures or books, augmented reality and maybe even virtual reality.

One laptop per child idea applied to education. Simplify the device so that it doesn't need a laptop and can be used for education. With the internet becoming ubiquitous (5G), the Monitor without a computer can be used for delivering MOOCs as well as tests.

5. Test-Taking Procedure

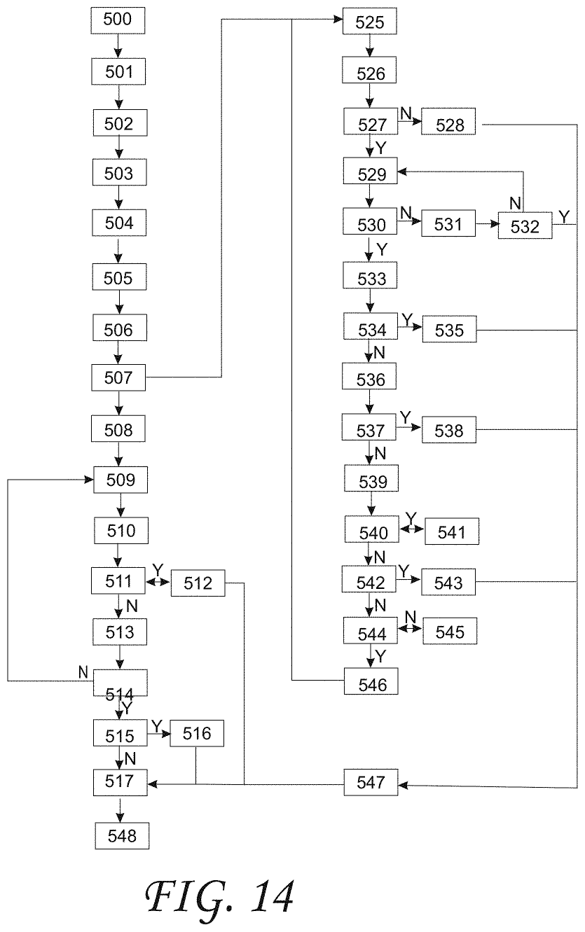

A representative test-taking sequence is illustrated in FIG. 14 and can comprise the following steps, again not all are required:
500 User selects test to take
501 Web server obtains the test from the test-provider
502 Monitor/Device creates cryptographic key set based on iris code and proprietary algorithm
503 Web server obtains public key from Monitor/Device
504 Web server processes and encrypts the test using Monitor/Device public key
505 Encrypted test is transferred to Monitor/Device using https:
506 Monitor/Device decrypts test using its private key
507 Start test monitoring
508 Start test timer and initialization of other parameters (pupil, # of pauses etc.)
509 Monitor/Device displays next test question
510 User chooses multiple choice answer using mouse which is recorded
511 Has allotted time been exceeded?
512 Display “maximum test time exceeded”
513 User advances or goes back to another question or indicates test is done
514 Is user done taking test?
515 Has pupil size change flag been set?
516 Send warning message to server “possible fake iris contact lens in use”
517 Display “End of test”, transfer test answers to server, stop monitoring
525 Start test monitoring tasks
526 Acquire iris image—flash white LED or turn on IR LED
527 Compare iris image with memory
528 Display “Iris has changed, unrecoverable error”
529 Acquire eye location image, measure pupil diameter and set flag if pupil diameter has changed
530 Is eye located properly and has pupil diameter changed
531 Display “eye location error, test paused, right click to restart”
532 Increment pause counter, check for maximum pauses and sense right click
533 Acquire cross-view camera image
534 Analyze cross-view camera image for anomalies
535 Display “cross-view image contains an anomaly, unrecoverable error”
536 Acquire forward view camera image
537 Analyze forward view camera image for anomalies
538 Display “forward-view image contains an anomaly, unrecoverable error”
539 Activate buzzer
540 Acquire and analyze sound interval from microphone
541 Display “warning sound from microphone contains an anomaly”
542 Acquire interval of sound from contact microphone
543 Display “User is talking, unrecoverable error”
544 Acquire and analyze interval of heartbeat data or skin temperature data from blood flow monitor and EKG data
545 Display “contact microphone not in contact with cheek contact”
546 Wait 1 second and then Continue
547 Display “Test terminated on error”
548 End of test (after 517)

When the test-taker engages in taking a second test later, a new biometric scan will be conducted to ascertain that this is the same person who originally registered using monitor 20. If this scan comparison is successful (as determined by a processor), then the display 27 will be activated and a signal can be sent by the processor to the test-provider to forward the encrypted test.

There are various sensors including the forward-looking camera, the iris imaging camera, the cross-view monitoring camera, and the microphone and contact microphone, that provide data which contain patterns which are appropriate for neural network analysis. In some cases, initially this analysis can be simplified by using differences between two images. For example, for the cross-view camera which monitors the space from the eye to the display, it is expected that the image from this camera should be invariant and therefore any significant changes in that image would be indicative of an anomaly which should be brought to the attention of the test-taker for remedial action. Similarly, once the test has begun, there should be no voices sensed by the microphone 24 or the contact microphone 38 and therefore if any voice frequencies are present, the anomaly can be highlighted for remedial action by the test-taker. This lack of sound requirement for microphone 24 may be difficult to enforce so a contact microphone 38 is provided to detect whether the test-taker is talking. If talking is detected, the test can be interrupted and if it happens a second time, the test can be terminated or other sound-detection responsive protocol followed.

Eye image analysis to detect that the eye is properly located in the FOV of the iris camera can be somewhat more complicated, however, again since it is the difference between two such images which is significant, the analysis can be relatively uncomplicated. Iris identification biometric software is commercially available and does not impose a significant problem. In order to guard against use of a contact lens with a painted surface showing an invariant iris image to an iris imaging camera, the size of the pupil is monitored by the monitor 20 via pupil image analysis. The pupil diameter changes over time even when the background lighting level is invariant. Therefore, if by the end of the test, the pupil has not changed in diameter such a painted contact lens is suspect and can be flagged as an anomaly.

A representative device assembly sequence is illustrated in FIG. 15 comprising the following steps (not all are required):
550 Assemble parts
551 Place CID in fixture
552 Place electronics and optics in fixture
553 Apply adhesive to display lens, camera lenses, contact microphone, heartrate monitor and CID edges
554 Close fixture
555 Wait for adhesive to set
556 Remove assembly with CID from fixture
557 Place in housing
558 Snap housing together

6. Monitor operation

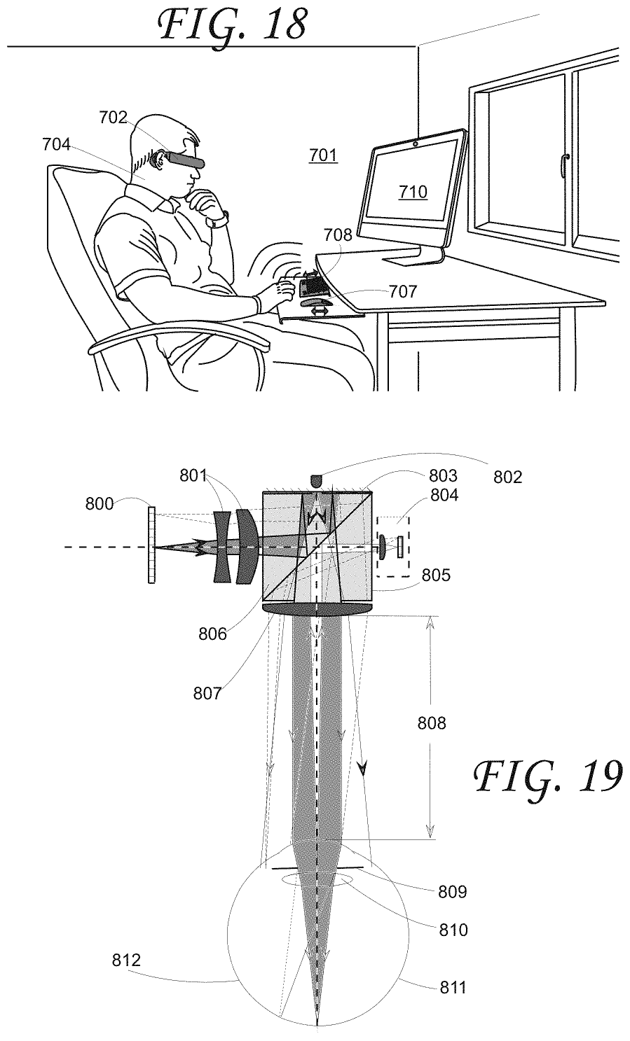

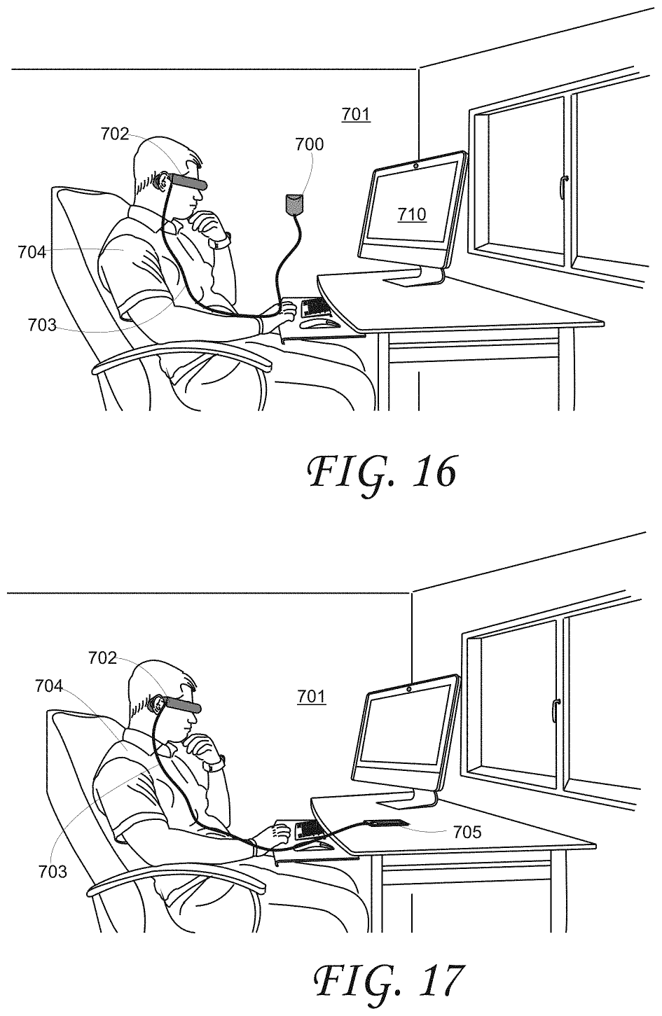

FIG. 16 shows a Wi-Fi module 700 plugged into a wall 701 via a cable 703 to provide power to the monitor 702. Alternatively, a battery pack can be provided removing the need for a wall connection and providing portability. A desktop or laptop computer with a display 710 can be used by the student for registering with a school or other institution which will provide the tests to be taken using the monitor 702. The connection to the Internet can be either arranged though the wall plug 700 which can contain a Wi-Fi receiver or through a Wi-Fi transceiver within the Monitor. Either the wall plug, or the Monitor, can also contain a Bluetooth receiver for interfacing to a mouse and/or keyboard.

FIG. 17 illustrates a situation, like FIG. 16, but where the monitor 702 plugs into a smartphone, PC or tablet (device) 705. In this case, the Internet and Bluetooth connections can be through the device 705.

The connection between the monitor 702, mouse 707 and keyboard 708 is illustrated in FIG. 18 with the following features:

a. Monitor 702 is started when mouse 707 or keyboard 708 is activated.

b. Mouse 707 or keyboard 708 can be used to control the display 710 for registration and test selection through an Internet connection, etc.

c. Other devices can also be controlled using the mouse 707 or keyboard 708 and are discussed below.

A test-taker can have access to a keyboard 708 and/or a mouse 707 for interacting with this server for initial registration (FIG. 18). Using a mouse 707 or keyboard 708, the test-taker initiates the test-taking process through communication with the test-provider or their institution's server (see FIG. 12). When the test is ready for execution by the test-taker, an encrypted version thereof is transmitted to the monitor 702 from the server via a network, see FIG. 12. An electronics package in the housing of the monitor 702 includes a processor that can utilize a private decryption key to decrypt the test questions and cause them to be displayed on the display within monitor 702, described above. The test-taker enters answers to the questions using the mouse 707 and/or keyboard 708 or other user interface.

Some precaution may be required in the case where a keyboard 708 is used to prevent the test-taker from using the keyboard 708 to communicate with a consultant. Keyboard 708, for example, may have a hidden switch that disconnects it from the monitor 702 and connects it to the consultant. The monitor 702 will know through the forward-viewing camera that the test-taker is entering information via the keyboard 708 and if that information is not detected by the monitor 702 through the keyboard interface, then communication to the consultant may be taking place and the test can be terminated or other appropriate remedial action taken.

7. Optical Analysis

FIG. 19 shows details of one possible version of the display optics used in the monitor 20, or any other monitor disclosed herein, and unless specifically addressed, are common optical components whose function is known or readily ascertainable by those skilled in the art to which this invention pertains. Other preferred designs are presented below. Components shown in FIG. 19 include:
800 is a display panel;
801 is a lens component;
802 is a LED to illuminate the iris;
803 is a mirror surface (reflective coating);
804 is an iris camera (including a projection-type lens and an image sensor);
805 is an absorbing coating on the side of the beam-splitter cube (not obligatory, helps to increase the image contrast);
806 is a beam-splitter cube;
807 is a main lens;
808 is a device-to-eye distance (the working distance);
809 is an iris;
810 is a crystalline lens;
811 is a retina;
812 is an observer's eye (an eye ball or a sclera).

Adjustment for nearsightedness and farsightedness can be accomplished, for example, through moving a display 800 or a lens 807, both of which are covered by the CID, as display 27 is covered by CID 22. If the position of the display 800 is used, then it should be positioned during assembly and prior to the application of the CID 22 or an adjustment mechanism would have to protrude through the CID 22. In the former case, the devices would need to be manufactured fitting different test-takers which would thus require several categories of devices to be stockpiled and it would also limit the general use of monitor 20 by several test-takers. If an adjustment mechanism is provided, the integrity of the CID 22 is compromised which may allow a path to the inside of the device where the contents of the display 800, for example are captured and transmitted to the consultant.

In the second case, the lens 807 can be left outside of the CID 22 making it easy to use for eyesight adjustment. In this case, however, the focal point of the iris camera would also change since it goes through the same lens. A self-focusing camera could be used for the iris camera to solve this problem or a lens system with a high f-stop yielding a long focal distance could be used. Alternately, the iris camera can be placed such that it does not go through the lens 807 by placing it below or to the side of the display optics.

FIG. 20 is a 3D-diagram of the display and iris-scanner module. The LED is not shown here. It is arranged along the axis lens 819 at the opposite plane of the cube beamsplitter, see FIG. 19. Other components in FIG. 20 include:
815 is a lens component;
817 is an iris camera;
818 is a display panel;
819 is a main lens;
820 is an entrance pupil of the eye.

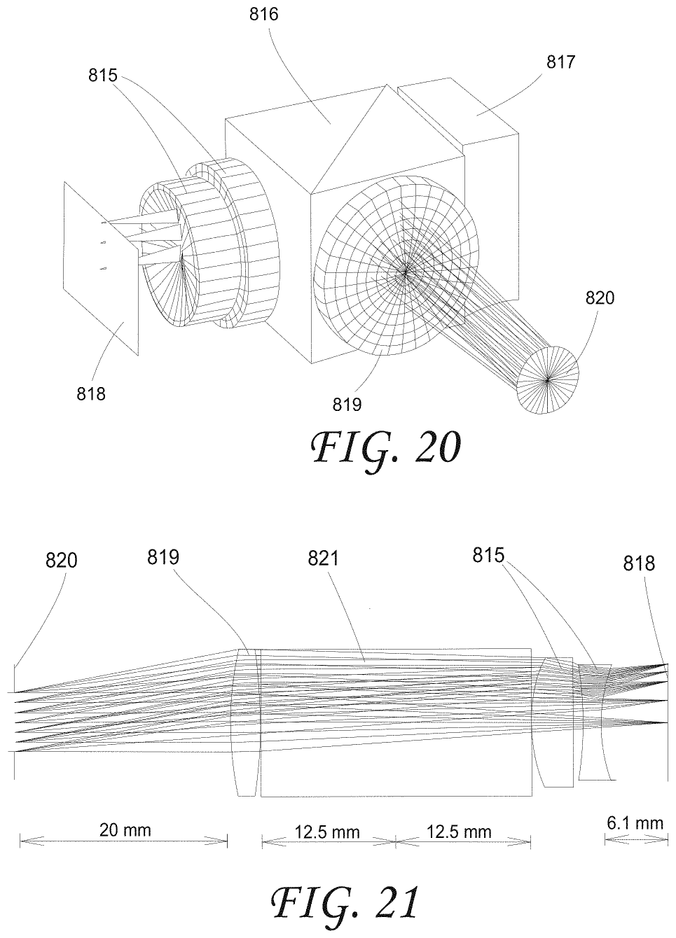

FIG. 21 shows a ray path in the display channel shown at a linearized in the reverse direction. As shown in FIG. 21, element 821 is a beam-splitter cube (here the full ray path is shown).

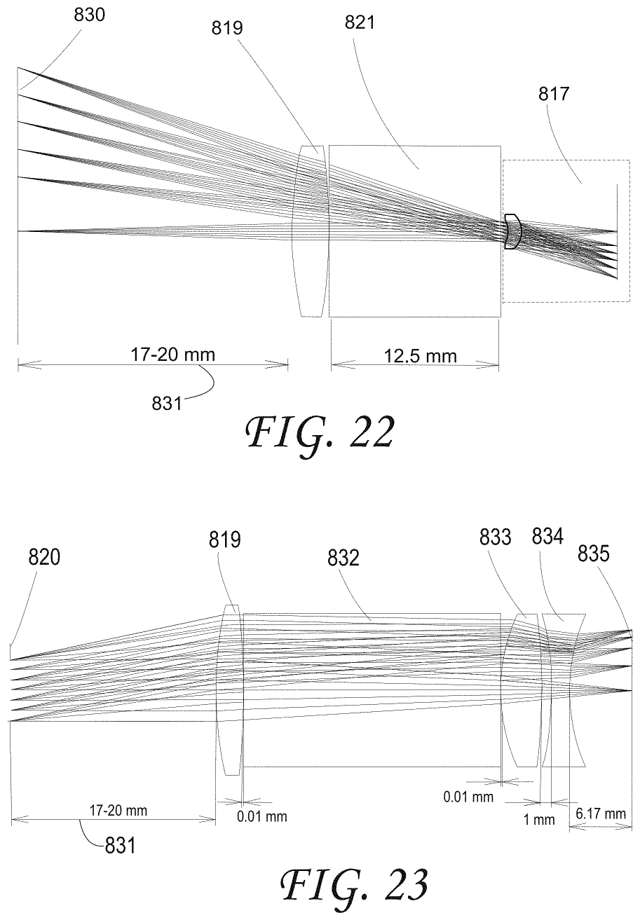

FIG. 22 shows the ray path in the iris-scan channel shown at a linearized scheme in the forward direction. Components shown in FIG. 22 include iris camera 817 (including a projection-type lens and an image sensor);
830 is a linear field of view of the iris camera (a plane of the iris)
831 is a device-to-iris distance.

FIG. 23 shows lens prescription data, including 832 is a beam-splitter cube (here the full ray path is shown);
833 is a positive lens of the lens component;
834 is a negative lens of the lens component;
835 is a display panel.

Table 1 shows characteristics of different lens considered for use in any of the monitors disclosed herein.

TABLE 1

| | First | Second | | | Light zone | Lens |
|---|---|---|---|---|---|---|
| Lens | radius, | radius, | Thickness, | | Diameter, | Diameter, |
| # | mm | mm | mm | Glass | mm | mm |
| 1 | 25.726 | −50.16 | 2.7 | N-PK51 | 12.5 | 14 |
| 2 | 12.75 | −44.508 | 4 | N-PSK53 | 11 | 12.5 |
| 3 | −21.428 | 13.046 | 1.7 | N-SF4 | 10 | 12.5 |

8. Alternate head mounting systems

FIG. 24 is an alternate frame design including a plastic headband 900 connected to a housing 903 (like housing 21), and it can be also be in the form of elastic band for better fixing the device on the test-taker's head, i.e., end 904 is connected to the glasses 910 (not shown). A USB cable connected to the device is shown as 901 in FIG. 24.

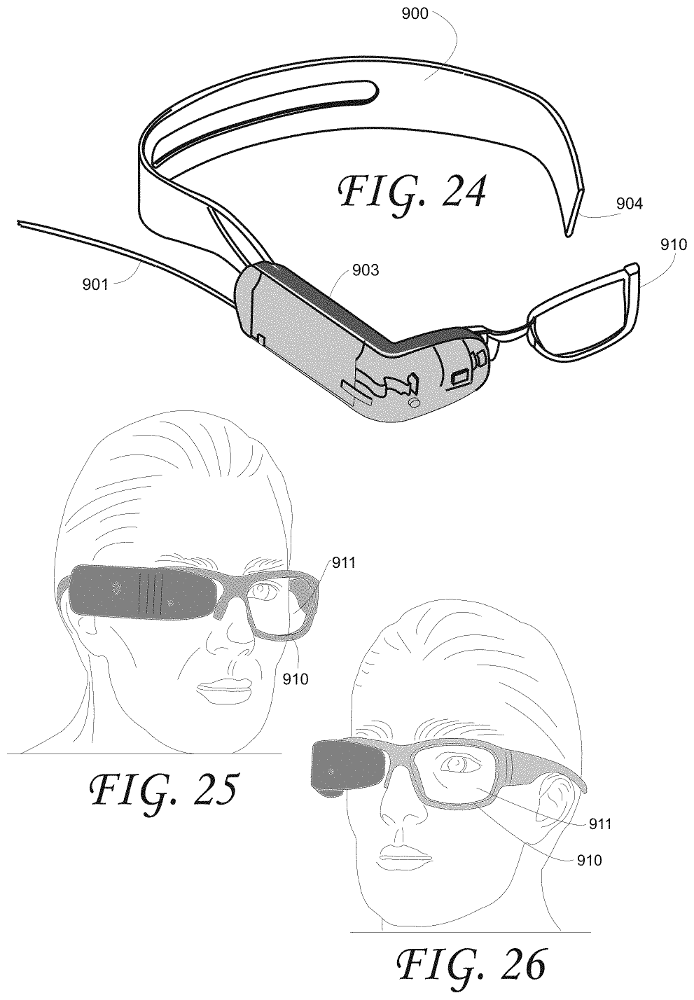

FIGS. 25 and 26 show another variant of glasses rim 910. A see-through lens as with ordinary vision correction glasses is shown as 911, but the device can be without such a glass lens.

9. Alternate Monitor design

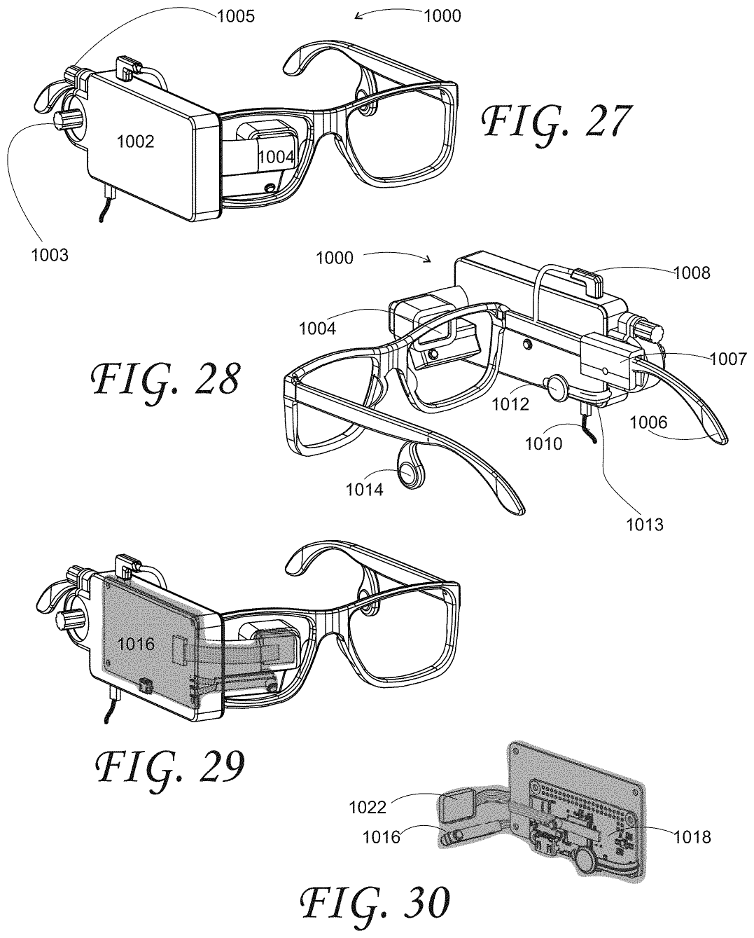

FIG. 27 is a front view of another version of the monitor which has many of the features of other monitors disclosed herein and the same or similar functionality. In this embodiment, shown generally at 1000, the electronics are contained in a housing 1002 and a display is shown at 1004. Knobs 1003 and 1005 are used to clamp the housing of the electronics and display assembly at a desired orientation and to permit rotation about lateral and vertical axes. For example, the knobs 1003, 1005 can be configured such that rotation of each knob 1003, 1005 causes a change in the distance between the housing 1002 and the frame. This allows the test-taker to adjust the display 1004 to properly align the display with the test-taker's eye. The housing 1002 and the display 1004 thereof are therefore adjustable in position relative to the eyeglasses frame. Any adjustment mechanism to provide for this variable position may be used, with the knobs 1003, 1005 being only an exemplifying embodiment.

FIG. 28 is a view of the monitor 1000 from the rear showing a glasses frame 1006 and adjustable clamping mechanism 1007 for attaching the housing containing the electronics to a temple of the glasses frame 1006. Clamping mechanism 1007 includes the two knobs 1003, 1005 that provide for the adjustment of housing portion relative to the glasses frame 1006. The clamping mechanism 1007 is clamped to the glasses frame by tightening screw 1011 which allows the entire assembly to be positioned relative to the glasses frame.

Power is supplied to the monitor 1000, e.g., through wire 1010. A contact microphone 1012 is provided and presses against the skin of the test-taker by means of spring 1013 connected to housing 1002. Spring 1013 extends from the housing 1002 inward, i.e., toward the opposite temple. The contact microphone 1012 is arranged proximate or at an inward end of the spring 1013 and is biased to be further outward from the temple so that when the monitor 1000 is worn, the spring 1013 may be compressed and thus exerts a force against the skin of the wearer thereby maintaining contact between the contact microphone 1012 and the skin of the wearer or test-taker. A sound generator, such as a contact speaker 1014, is provided on the other temple of the glasses frame 1006. Microphone 1012 and speaker 1014 are in electronic communications with the processor in housing 1002 to operate as disclosed above. The contact speaker, also called a bone speaker, emits an audible sound as well as a vibration to the skin and/or bone of the test taker. This audible sound can be used to test the audio microphone 24 replacing sound creator 28.

The test-taker is generally forbidden from talking during the test, to prevent the test-taker from orally supplying test questions to an accomplice. The microphone 24 could be used for monitoring the test taker's talking, however, other sounds in the environment would also be recorded by such a microphone and it would be difficult to differentiate the communication by the test-taker from sounds that might be in the environment. A contact microphone will only detect sound vibrations coming through the skin of the test-taker and ignore all other sounds. Therefore, it is a preferred method of determining whether the test-taker is talking. For this system to work, the contact microphone 1012 must be in contact with the skin of the test-taker. Various techniques can be used to determine that this contact is taking place such as an optical sensor that looks for the skin of the test-taker, a capacitive sensor that determines the capacitance of the skin, a temperature sensor that measures the skin temperature among others. Each of these methods can potentially be defeated through such techniques as placing a sound-blocking material between the contact microphone and the skin such that the material does not interfere with the optical, capacitance or temperature sensors.

To address this issue, the contact speaker 1014 is preferably placed on the opposite side of the test-taker's head. Contact speaker 1014 can be programmed to periodically transmit a sound through the head of the test-taker to the contact microphone 1012 and to the audio microphone 24. If both contact devices are in contact with the skin of the test-taker, the transmission will be detected by the contact microphone 1014 thereby confirming that the monitor 1000 is properly in place.

The bone microphone should be activated with voice recognition whenever it hears anything. The audio microphone should be activated whenever there is a transmission from the audio speaker and when it hears talking. If the test-taker finds a way to defeat the contact microphone and talks, the audio microphone should pick it up. It the environment is too noisy, then the test can be paused until the noise quiets down. The student should not be taking a test in an environment where there is excessive talking.

Prior to the start of a test, the student can be asked to state his name and both microphones should be able to record this response. If there is any doubt about activation of the bone microphone, or at other random times, the test can ask the test-taker to restate his name. Both microphones should register the response without an unreasonable delay. In another version, there is more than one microphone in the headset so that the location of the sound source can be triangulated.

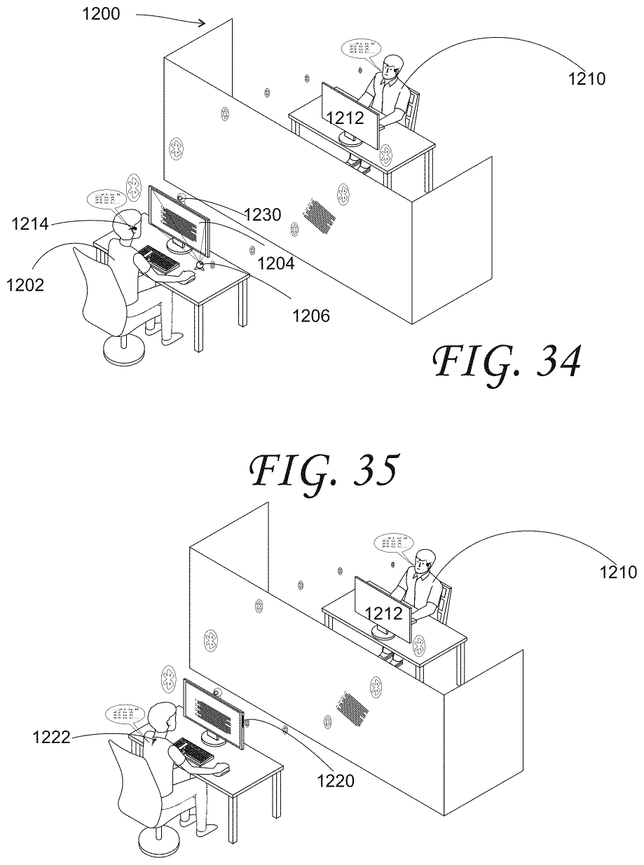

FIG. 29 illustrates use of chassis intrusion detector, CID, 1016, like CID 22 described above or any other CID disclosed herein, with this design. FIG. 30 additionally shows electronics 1018 from an inside view that is covered by CID 1016. Display 1022 is similarly covered by the CID 1016.

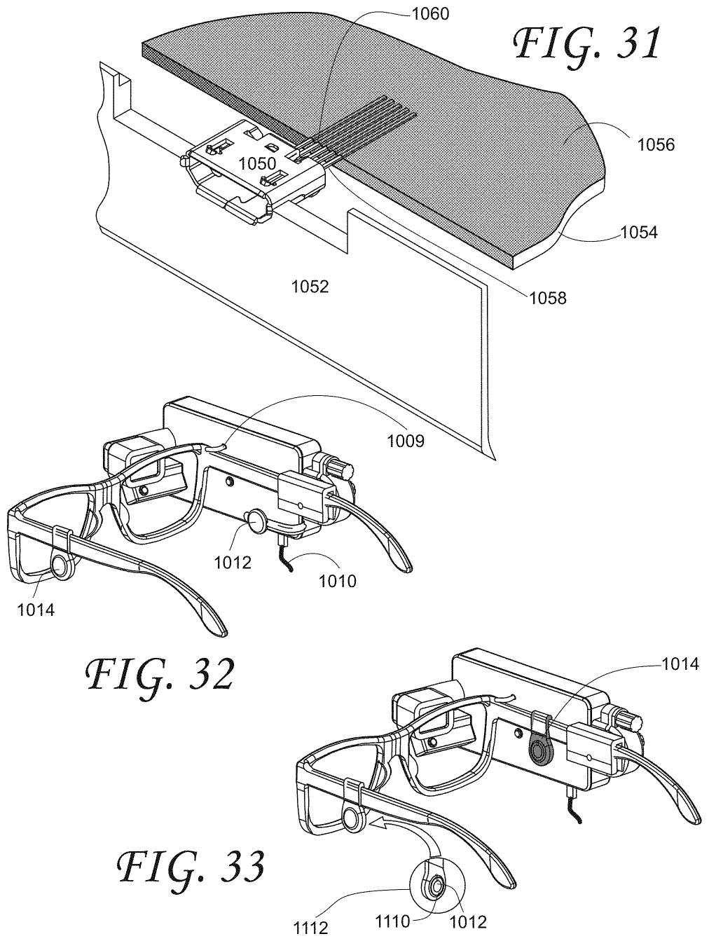

FIG. 31 illustrates an exemplifying method of attaching a USB connector for supplying power to a monitor through a CID 1056 or CID 22 or any other CID disclosed herein. CID 1056 is shown covering a portion of a PC board 1054. A USB connector 1050 is attached to housing 1052. USB connector pins 1058 pass through small holes 1060 provided in the CID 1056. These holes 1060 are sufficiently small that it would be very difficult for anyone to defeat the CID 1056 through these holes 1060. The illustrated monitor may be any of the monitors disclosed herein.

FIG. 32 is a view like FIG. 28 showing the contact speaker 1014 and contact microphone 1012. Contact speaker 1014 has been moved forward on the temple of the glasses frame 1006 in order to accommodate bearded test-takers. A movable connection of the contact speaker 1014 to the temple is provided. The connection from the speaker 1014 to the electronics is through wire 1009 that may pass through an interior space in the temple and lens portion. Wire 1010 goes from the USB connector described in FIG. 31 to a source of power such as a wall outlet.

FIG. 33 illustrates the addition of an EKG sensor in the form of a thin film 1110 which is placed on top of the contact microphone 1012 (to form a microphone assembly) and the contact speaker 1014 (to form a speaker assembly). In FIG. 33, both the contact microphone 1012 and contact speaker 1014, with EKG sensors, are moved forward on the temples of the glasses frame 1006 so that they contact skin of bearded people. Note that the contact microphone 1014 is covered with the CID whereas the contact speaker 1012 is not. Both devices could be covered with CIDs but it may not be necessary to cover the contact speaker.

The EKG sensors, also known as electrocardiogram sensors or ECG sensors, allow for the measurement of the heartbeat shape and serves as a further verification that the contact speaker and microphone are in contact with the skin. An EKG also provides an alternate biometric verification of the identity of the student. Since the signal levels for EKG measurements are very low, the sensor pads cannot be covered by the CID. This issue can be resolved by allowing two conductors to be placed through the CID allowing the EKG pads to be glued to the outside of the CID. The remainder of the contact microphone can be placed inside the CID cover.

10. Dual eye monitor

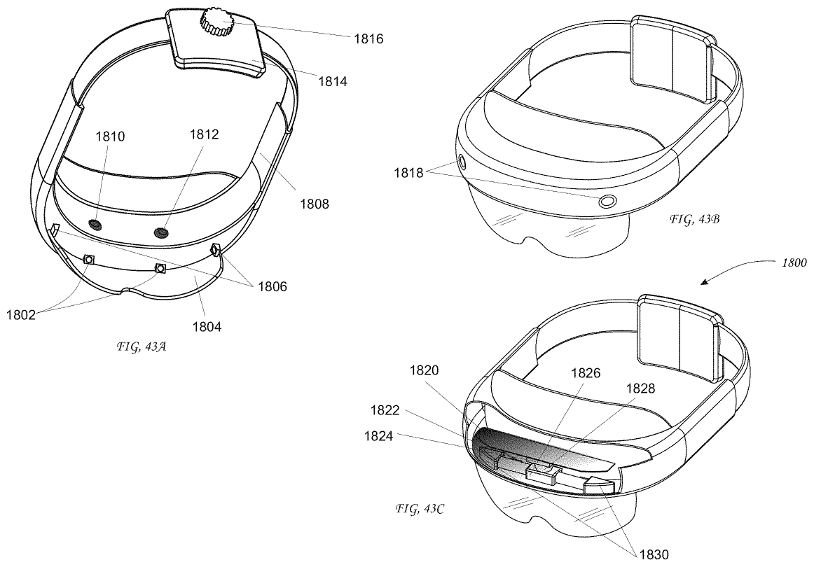

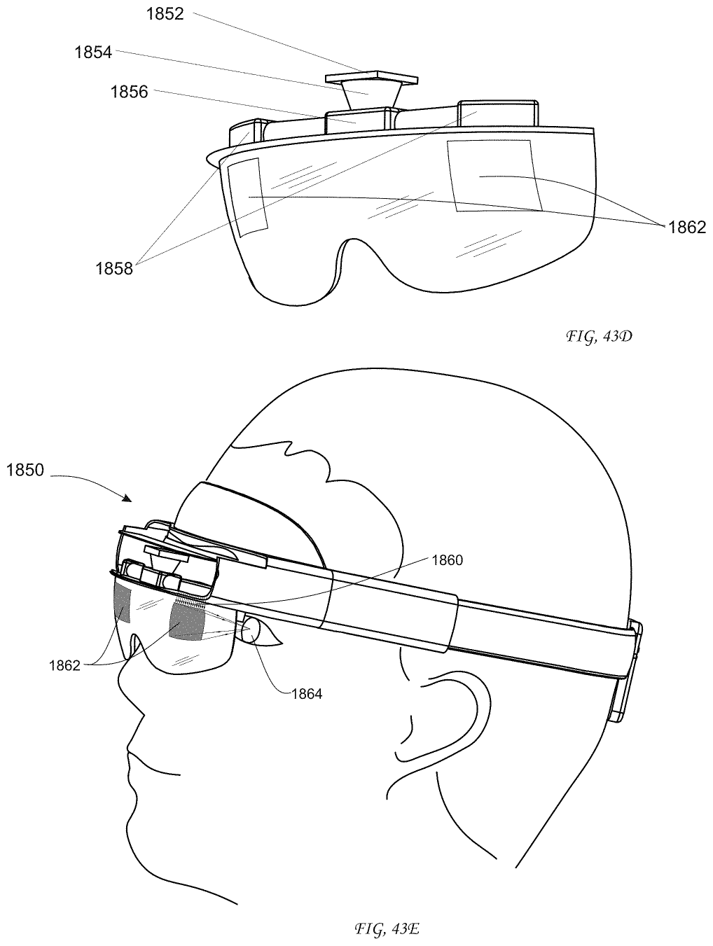

An alternate monitor design which provides an image to both eyes is illustrated in FIGS. 43A-43E. In this design, the components, which are preferably protected by a CID 1822, are more closely arranged to simplify the CID design. Specifically, a single display panel 1852 is used to illuminate lenses 1862 seen by each eye (FIG. 43D). Two iris cameras 1802, two crossview cameras 1806, and two forward cameras 1818 can be implemented in this design. Since the display will be seen by both eyes, both eyeballs 1864 must be monitored to guarantee that the device has not been rotated or in some manner pulled away from either eye to permit a foreign camera to be inserted. The crossview cameras 1806 similarly must now watch both sides of the test-taker's head to search for nefarious cameras inserted by the test-taker. Sensor assemblies 1810 and 1812 are provided on each side of the forehead (FIG. 43A). These sensor assemblies 1810, 1812 measure the EKG and sound emitted by the test-taker's head. Sensor assembly 1810, for example, can contain a contact speaker and EKG sensor. Similarly, sensor assembly 1812 can contain a contact microphone and ECG sensor. The contact microphone of sensor assembly 1812 will determine when the test-taker is emitting sounds and the contact speaker will be used to test that the contact microphone is in contact with the test-taker's skin as described in the previous monitor examples. The contact speaker can also emit an audio sound and thus can be used to test the audio speaker, not shown, if present. Since the EKG sensor pads must be sensitive to very low voltages, they generally will be placed on the outside of the CID 1822. A small pair of contacts can be placed in the CID 1822 to permit signals to be passed from the EKG sensors to the interior electronics. The EKG sensor pads can be appropriately attached to the CID 1822 by gluing in such a manner that any attempt to remove the EKG pads will destroy the CID 1822. Two forward or front view cameras are provided in order to increase the field of view of the sensor system and also to permit future 3D images to be created when augmented reality is implemented into this design. Although not shown, the optical system can be arranged such that alternately polarized frames can be fed to the right and left eyes of the test-taker wherein the single display panel can pass the information to the eyes to permit 3D holographic viewing.

The monitor in this example contains a headband 1808 with an adjustment nob 1816 to permit the apparatus to the securely mounted to the test-taker's head. A battery 1814 can also be integrated with the device and placed at the rear of the monitor to balance the forces from the monitor on the head of the test-taker. In this manner, the center of gravity of the monitor can be adjusted to be placed near the center of the test-taker's head. Under these circumstances, there should be little tendency for the monitor to slip forward or backward. The battery 1814 now can be considerably larger than in previous designs and designed to provide many hours of operation without an external power source.

The display panel 1852 projects images downward through lenses 1854 to a beamsplitter and mirror assembly 1856 which sends alternately polarized light to the left and to the right (FIG. 43D). Thus, the display image is split into two images alternately polarized. The projectors 1830 then project the light down toward the lenses 1804 which contain reflecting surfaces/lenses 1862 and reflect the light into the eyes 1864. Each lens 1862 can be differently polarized so that the light which is polarized horizontally for the right eye, for example, interacts with a vertically polarized film on the right lens. This has the effect of making the right lens act as a mirror preventing the image from being seen from in front of the monitor. Similarly, the polarized image for the left eye which can be polarized vertically, for example, would interact with a polarized lens 1862 that polarizes horizontally for the left eye.

In an alternate arrangement, not shown, the light from the projectors will project to the rear of the device to locations on either side of the head where a mirror would change the direction of the image and projected toward the polarized lenses for viewing by the test-taker. This method simplifies the design of the lenses eliminating the need for reflector services to change the angle of the light to be integrated into the lenses.

Several adjustments are encompassed by the invention. An adjustment of the projector angles, or the mirrors that reflect the image to the lenses, can be used to accurately aim the reflections into the test-taker's eyes thereby accommodating any variance in the inter-pupil distance for different people. The lenses can be a compound lens arrangement whereby the outer lens corrects for prescription lens as needed for people with different requirements. The inner lens can be the one from which the reflections to the eyes are made. These two sets of lenses can be designed so that the outer lenses are interchangeable depending on the visual needs of the test-taker. The inner lens can be incorporated within the CID thus eliminating the possibility of a test-taker placing a camera that could see the inner lens and the display. The focus of the display can be changed by moving the various optical components. Under this arrangement the field of view can be controlled so that it can only be seen by the test-taker's eyes.

In this monitor design, provision can be made for augmented reality devices such as a virtual smartphone, mouse or keyboard for use by the test-taker. These can require that the fingers of the test-taker be recognized and mapped in such a way that the motion of the fingers can be accurately tracked and understood. The virtual keyboard can be attached to the test-taker's fingers or to a table that is either virtual or appears in the environment.

The arrangement in this design also lends itself for holographic presentations.

11. Alternate Displays

Until now a simple direct projection display has been illustrated where the display is in the form of a projector directing the image directly into the eye. This has the disadvantage of blocking a view of the surrounding environment when the image is not being viewed. Similarly, this design is limited to implementation for a single eye.

Other options include reflective displays where the projector sends the image directly toward a lens in front of the eye and waveguide displays where the maximum freedom is provided for the location of the display projector relative to the eyes.

Both the reflection and the waveguide displays require a display element that displays the image for further processing by the optical system. Preferred technologies include Liquid Crystal on Silicon (LCoS) and Active Matrix Organic Light Emitting Diodes (AMOLED).

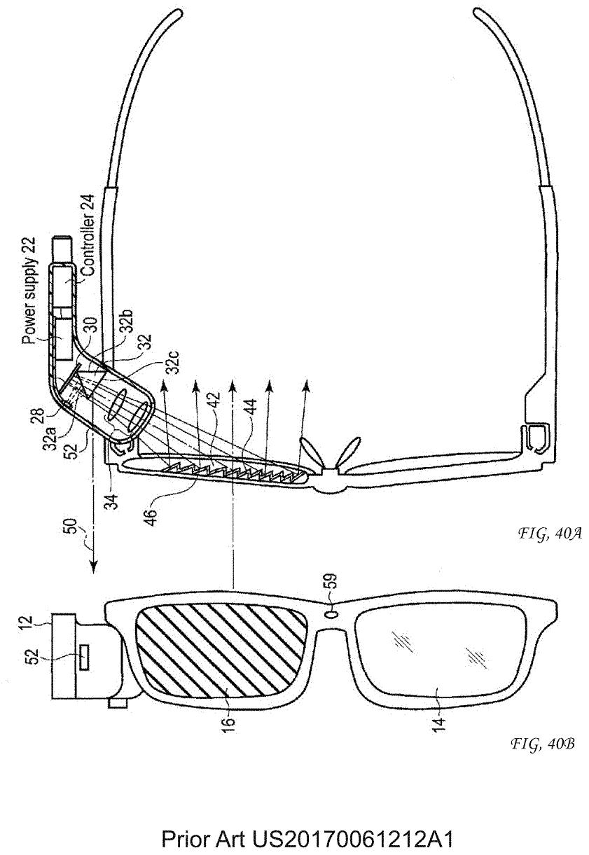

FIGS. 40A and 40B illustrate a preferred design of a monitor using a reflector display taken from 20170061212 (FIGS. 2A and 2B therein). This prior art is incorporated by reference in its entirety. The call out numbers on these figures refer to the disclosure in US 20170061212. This basic reflector design can be modified to incorporate the CID, iris, forward and crossview cameras, contact microphone and speakers, EKG sensor and other features disclosed herein. It is included here as an example of the use of a waveguide display. Another prior art reflector design is disclosed in US20170336634 incorporated by reference herein.

FIG. 41 illustrates a preferred design of a monitor using a waveguide display taken from U.S. Ser. No. 10/180,572 (FIG. 1 therein). This prior art is incorporated by reference in its entirety. This basic waveguide design can be modified to incorporate the CID, iris, forward and crossview cameras, contact microphone and speakers, EKG sensor and other features disclosed herein. It is included here as an example of the use of a waveguide display. The call out numbers in this figure refer to the disclosure in U.S. Ser. No. 10/180,572.

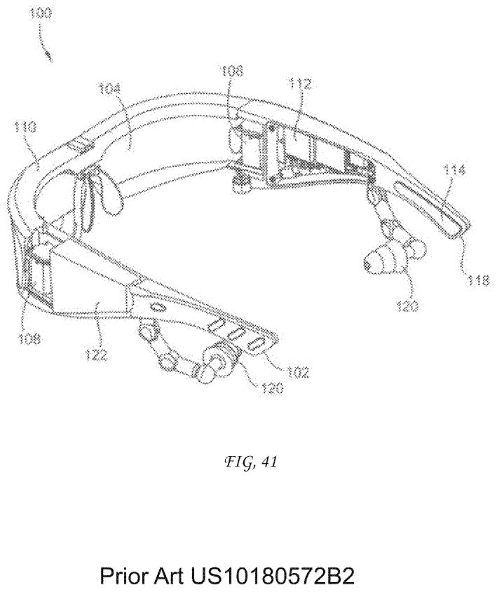

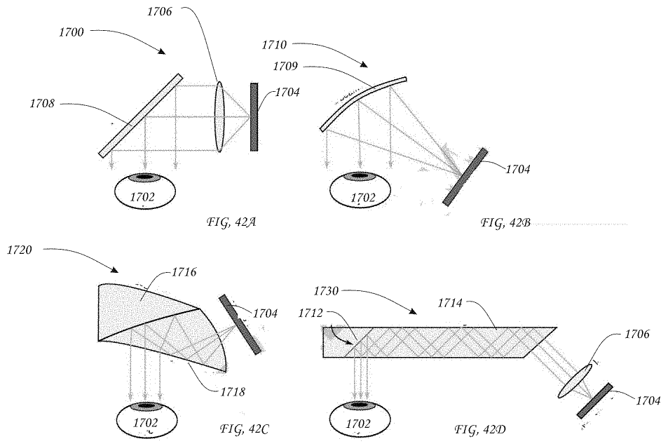

FIG. 42A-42D illustrate common optical designs for see-through near-eye displays. Each diagram shows how the light from one pixel in a display panel propagates through the display optics to create an apparently distant point here at optical infinity. These diagrams were adapted from Computational See-Through Near-Eye Displays, by Andrew S. Maimone, Ph. D. dissertation 2015, University of North Carolina at Chapel Hill.

FIG. 42A is an example of a simple combiner, FIG. 42B is an example of a curved combiner, FIG. 42C is an example of a freeform prism and FIG. 42D is an example of a waveguide. Any of these optical designs and others can be implemented in the Monitor and the inventions disclosed herein are not limited to a particular optical design.

In FIG. 42A, light is emitted from a display panel 1704 and captured by a lens 1706 which passes the light to a beam splitter or a polarized lens 1708 which transmits the light to the eye 1702. In FIG. 42B, the initial lens is eliminated and the polarized lens 1709 is curved. In FIG. 42C, the lens and reflecting functions are performed by a free form prism 1718 and a see-through corrector is used to correct for the distortion of the freeform prism on light from the environment. Finally, in FIG. 42D, a waveguide 1714 is used in place of the polarized lens. The light is reflected out of the waveguide by reflector 1712 to the eye 1702.

12. Classroom Testing

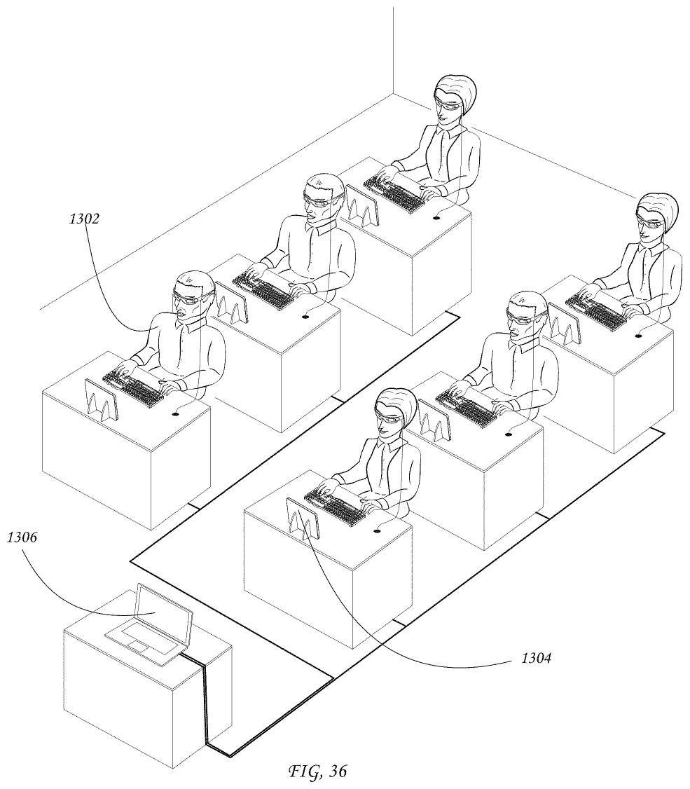

FIG. 36 illustrates the use of the apparatus in accordance with the invention by a room full of test-takers where each device can be attached to a central computer 1306 through a USB port, for example. The Test Glasses (Monitors) can be used by test-takers remotely located from the institution providing the test. Alternatively, as illustrated in FIG. 36, the Monitors can be used by a room full of test-takers where each device is attached to a central computer 1306 through, for example, a USB port. In this case, each test-taker 1302 is provided with a keyboard and/or a mouse or other input device, and a display 1304. Each of the devices can be connected to a central computer 1306. Otherwise, the operation of the Monitors is as described above

FIG. 37 is a view similar to FIG. 36 where the answers are placed on a piece of paper which will be collected by the test proctor at the conclusion of the test. Again, since each test-taker will be taking the same test with the questions randomly reordered, there is no advantage in a test-taker surreptitiously communicating an answer to another test-taker. Thus, by virtue of the arrangements depicted in FIG. 36 and FIG. 37, the Monitors can be used either remotely or in a classroom environment.

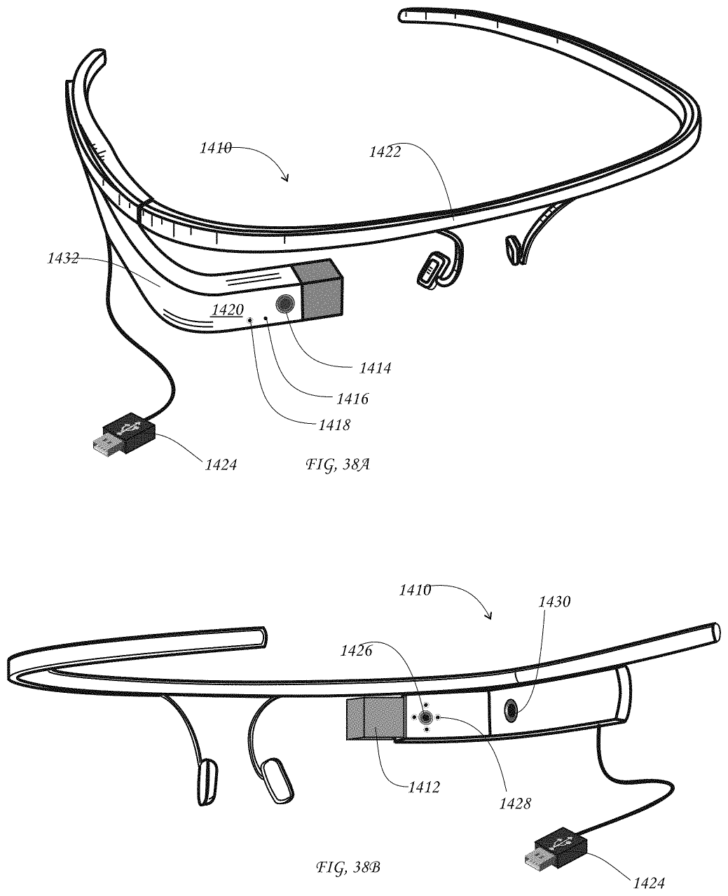

A device constructed in accordance with the teachings of this invention is illustrated in FIG. 38A which is a perspective view of a head worn glasses type device, the Test Glasses or Monitor, containing an electronics assembly with several sensors, cameras and a display all protected with a chassis intrusion detector prepared using the teachings herein. A head worn display and electronics device constructed in accordance with the invention is shown generally at 1410 in FIGS. 38A and 38B.

A housing 1420 extends from a frame 1422. Housing 1420 is substantially L-shaped with a first portion extending straight outward from an edge of the frame 1422 and second portion perpendicular to the first portion and positioned in front of the frame 1422.

A display 1412 is arranged on or in the housing 1420 and pointed toward the right eye of test-taker displays the test questions (although alternatively, a display can be pointed toward the left eye of the test-taker). A forward viewing camera 1414, representative of an imaging device, is also arranged on or in the housing 1420 and monitors the field of view of the test-taker outward from the device 1410. The camera 1414 can have a field of view of approximately 120°. A microphone 1416 is also arranged on or in housing 1420 and monitors talking (sounds) which can take place while the test is in progress. A sound maker or speaker 1418 is arranged on or in the housing 1420 and periodically provides a sound detectable by the microphone 1416 to verify that the microphone 1416 has not somehow been rendered inoperable. The speaker may be placed further away from the microphone and insulated from the housing so that the microphone does not receive the sound from the speaker through the housing instead of the air surrounding the Monitor.

The display 1412 is arranged at a terminal end of the second housing portion. The forward viewing camera 1414, or more generally an imaging device, the microphone 1416 and the speaker 1418 are also arranged on the second housing portion (see FIG. 38A).

Each of these components 1412, 1414, 1416, 1418 is connected to a processor-containing electronics package in housing 1420 which is mounted to the glasses frame 1422 in a manner known to those skilled in the art to which this invention pertains. A cable emanates from the electronics package in housing 1420 and can contain a USB connector 1424 for connecting onto an external device such as a computer.

An iris or retinal scan camera 1426 is arranged on housing 1420, pointing inward toward the wearer, and measures biometrics of the test-taker (see FIG. 38B). Such biometrics can include an iris or retinal scan or a scan of the portion of the face surrounding the eye. Illumination of the eye can be provided by LEDs 1428 arranged on the housing 1420 which can be in the IR or visible portions of the electromagnetic spectrum. Two or more different levels of visible illumination can be provided to cause the iris to be seen at different openings to check for an artificial iris painted onto a contact lens. The iris scan camera 1426 and LEDs 1428 are arranged on the second housing portion (see FIG. 38A).

A camera 1430 can also be provided on or in housing 1420 to check for any anomalous activity which might take place in the vicinity of the glasses 1410 (see FIG. 38B). Such a camera 1430 can enable detection of whether an image capture device has been either temporarily or permanently affixed to the device 1410 or to the face of the test-taker which can capture the image on the display 1412. Similarly, camera 1430 can monitor the space surrounding the left eye of the test-taker to assure that such an image capturing device and or another display for providing aid to the test-taker is not being employed by the test-taker in conjunction with his left eye. The camera 1430, or more generally an imaging device, is arranged on the first housing portion and oriented to image most of the frame 1412 (see FIG. 38B).

Software and a processor which controls administration of tests is resident on the external computer, in the electronics package in housing 1420, or in another device, not shown, which attaches to the device 10 through connector 1424. A test-taker will have access to a keyboard and/or a mouse for interacting with this computer, not shown. Using a keyboard, the test-taker can initiate the test taking process through communication with the test provider. When the test is ready for execution by the test-taker, and encrypted version of the test is transmitted to the computer and relayed to the device 1410. The electronics package in housing 1420, e.g., including a processor, utilizes a private decryption key to decrypt the test questions and cause them to be displayed on display 1412. The test-taker then enters the answers to the questions using the keyboard and the computer display.

13. Communication

Communication from the monitor to the Internet and other devices generally involves use of Wi-Fi and Bluetooth. Communication generally will involve the sending of test and answers between the monitor and an Internet resident server. In some versions of the Monitor, direct cellphone communication will also be available. This will become increasingly important as the cellphone data transmission speeds increase. The best method of communicating with the Internet will soon be through 5G and thus Wi-Fi, although available, maybe used less and less. The CID provides excellent hardware security, but the possibility still exists for software malware to enter the monitor through one of the communication channels. One method of guarding against search malware becoming resident on the Monitor is to require that all communications other than Bluetooth with the Monitor take place through a secure Internet resident server. This server would scan all transmissions intended for the Monitor to make sure that no malware is present.

When using the Monitor, it may be desirable to use the computational resources of external devices such as smart phones and PC computers. This can be accomplished using various input methods to send data and commands to the external device. These methods include using a physical or virtual mouse and or keyboard or orally. For some special applications, alternative data input devices may be utilized with the monitor providing proper software and hardware is provided. One such device is a clicker which can be used to answer multiple choice questions. Another is a ring that has many of the functions of a mouse but resides on the finger of the test-taker. Such a ring, in some cases, can have a camera which can be useful for taking a picture of the test-taker to help in verifying his or her identity. As with cell phones, the Monitor can also be used to control external devices such as radio or TV stations, lights, door locks, etc.

14. Additional hardware

Additional hardware that can be incorporated into or added on to the Monitor includes:
1. A laser pointer to allow selection of a point in the surrounding environment. This can be used in conjunction with augmented reality to locate a particular point where the augmented reality device should appear. This laser pointer can be augmented with lighter capabilities to allow, on a limited basis, the determination of the distance to the object that is being selected. See for example U.S. Ser. No. 10/152,141.
2. In addition to stereo cameras and lidar, structured light can also be used to map the geometry in the surrounding area to the Monitor. In this case, patterned light beams can be sent from, for example, different sides of the Monitor and the interference of these structured patterns would determine the distance from the monitor. See U.S. Pat. No. 7,182,465.
3. A 360 degree camera can be mounted onto the top of the Monitor using a separate strap which provides the capability of monitoring and photographing the entire space surrounding the test-taker.
4. GPS can be added where it is desirable to know the location of the Monitor.
5. An IMU can be added where the kinematic or rotational motion of the head of the test-taker is desirable. Such a device can be used, for example, to register head motions for the control of various functions depending on the programs present and running on the Monitor's CPU.
6. A magnetometer can additionally be added to help orient the monitor.
7. The best way to add a functioning keyboard to the Monitor is through use of a virtual keyboard. This virtual keyboard would be displayed in the field of view of the test-taker as would his hands relative to the keyboard. By watching the test-taker typing, the characters that were intended to depress can be recorded. Alternatively, a physical keyboard can be used however this poses some unique problems. The keyboard must not have the capability of transmitting data to any place other than the Monitor. If it can do so than the keyboard can be used to type questions to a consultant. Someone could design a keyboard with a hidden switch which sends a wireless signal to the consultant which is not registered by the Monitor. If the Monitor determines that the test-taker is typing but it is not receiving the result of that typing, then the test can be terminated. Alternatively, the keyboard can be covered with the CID and can communicate to the Monitor using encryption.
8. In order to positively prevent any leakage of information from the lens upon which the test-taker views the test to the outside world, the lens can incorporate an electrochromic film which turns black when the test is underway.
9. Additional sensors can be mounted on the Monitor to monitor the health state of the test-taker, for example. A heart rate monitor, a temperature sensor and an EEC are three possibilities.
10. An ambient light sensor can be added to aid in the control of the various cameras.
11. A capacitance sensor can also be added to determine contact with the skin of the contact microphone. As mentioned above the blood flow sensor can also be used for that purpose as well as a skin temperature sensor. Additionally, a picture of the face skin can be used to measure the distance to the skin by having a very small depth of field or by using structured light or just a laser shined at an oblique angle.
12. An endfire microphone array can also be used in order to determine the direction of incoming sound. This can augment the contact microphone for determining when the test-taker is speaking or otherwise embedding sounds. Other combinations of multiple microphones can be used to localize source of speech. An earbud can also include additional sensors such as a microphone or array of microphones. In some embodiments, at least two microphones from a microphone array can be arranged along a line pointed towards or at least near the mouth of a user. By using information received by the orientation sensor or sensors, a controller within the earbud can determine which microphones of a microphone array should be activated to obtain this configuration. By activating only those microphones arranged along a vector pointed at or near the mouth, ambient audio signals not originating near the mouth can be ignored by applying a spatial filtering process.
13. Ultrasonic, IR, RF, and similar sensors can be added if the need arises.
14. Tactile or touch sensors can be added to allow for finger control of the monitor. Such sensors are used on Google Glass for example.
15. Systems are under development to allow direct communication from a person's brain to a device separate from the body. The concept is to allow for direct brain to Internet communication. Such a system could be used to defeat the cheating prevention systems described herein and therefore a device can be added to the Monitor to sense for such communications.
16. A magnetic compass can also be included in the Monitor.
17. Hand mounted sensors including camera, RF transmitter, LED,

15. Software

Various software modules that can be resident in the Monitor include:
1. Iris capture and recognition
2. Eyeball location
3. EKG capture and biometric recognition
4. Finger and hand recognition and monitoring
5. Voice recognition biometric
6. Sounds emanating from the test-taker's mouth
7. Nefarious object presence recognition in iris or cross view camera images.
8. Cryptographic key set determination from an iris code.
9. CID broken wire detection
10. School registration software

16. Non-Educational Applications

17. Breed U

18. Biometrics

19. Textbooks

20. Other Advantages of the System

21. Summary—Separate this into Several Sections

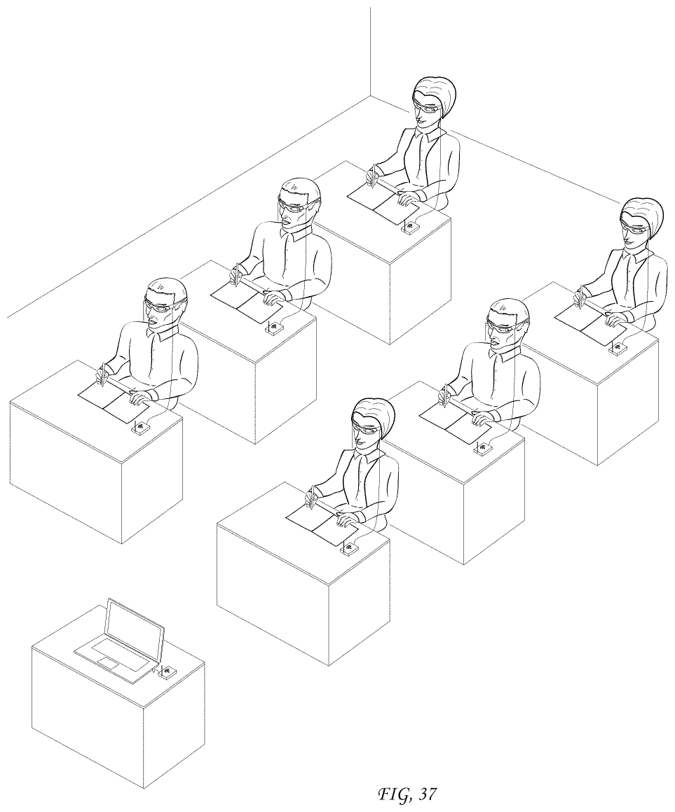

A key feature of this device is that it makes cheating almost impossible. FIG. 34 illustrates a method of cheating that would be available for remote-proctored exams where the proctor monitors the test-taker through a camera mounted on the test-taker's computer 1230. In FIG. 34, the test-taker 1202 has placed a camera 1206 on his table where it has a view of the display 1204 but is not observable from the proctor's camera 1230. Camera 1206 can wirelessly transmit images of the test to an accomplice 1210 remote from the room where the test is being taken. The accomplice 1210 can see the test on his display 1212 and wirelessly transmit the answers to an ear-mounted receiver 1214 worn by the test-taker 1202. The accomplice 1210 therefore can provide answers to the test-taker in a manner that cannot be detected by the proctor.

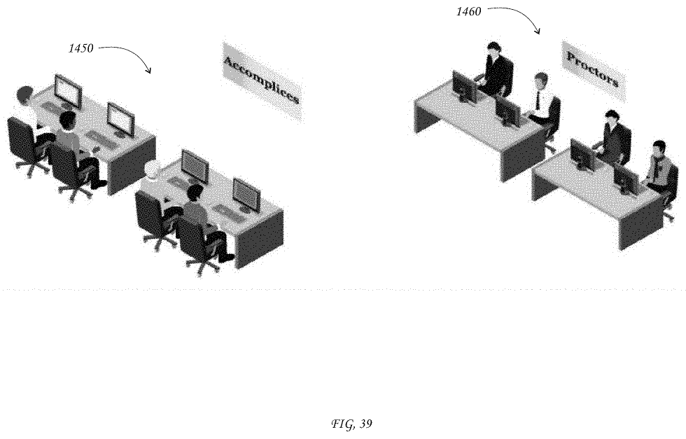

FIG. 39 represents the growth of the student test assistance industry. As more and more students begin taking tests online, more test providers will opt for using proctoring services 1460 in as attempt to stem the tide of cheating. Since it is not possible to secure the computer on which the student is taking the test, a call center industry 1450 devoted to aiding students desiring to cheat will spring up in the same manner that term paper writing companies have become established. The content of the test will be passed electronically to the accomplice at the cheating enabling call center 1450 who will pass the answers to the student electronically perhaps through a contact microphone affixed to the student's shoulder bone. Since this will not be perceivable by the proctors 1460, cheating will be successful and the cheating call center industry will thrive.

In addition to a direct connection to the student's computer, screen viewing cameras are easily installed that cannot be seen by a proctor. There are many other methods of placing a camera which cannot be observed by a proctor. These include mounting a camera on the wall of the room where the test is taking place but out of view of the proctor's camera. Some proctors require that the student rotate the camera around the room prior to taking the tests so that the proctor can see whether there are such cameras placed where they can see the test. In such cases, tiny cameras can be mounted on a wall or even the clothes of the test-taker which are unobservable, due to their minute size, by the proctor. The proctor may observe something strange in the ear of the test-taker in which case, a more sophisticated approach is shown in FIG. 35.

In this situation, a contact speaker 1222 is hidden underneath the clothes of the test-taker and to make the situation even more difficult, the test-taker's computer has been modified to include a Bluetooth transmitter 1220 which is capable of transmitting contents of the test to an accomplice 1210 in another room.

An objective of the test-taking system of some embodiments of this invention is that it is completely automatic without requiring intervention of any human other than the test-taker. The institution administering the test will have a limited set of rules which, if violated, will render the test invalid. These rules can be general rules or rules specific to the test being taken. These rules can include: the event(s) which will invalidate a test; the number of times that the test, once an event has occurred, can be restarted if any; the number of times that a particular test can be taken if failed; the time permitted to take the test; the number and length of pauses permitted during the test-taking process; etc. (these examples are not limiting of the possible rules). Some or all of the rules may or may not be communicated to the test-taker.

This puts a small burden on the institution to determine what constitutes cheating and the consequences. This is a relatively light burden with the test-taking apparatus of this invention, the Monitor, since once the rules have been set the opportunities for an undetected violation of these rules are very limited or nonexistent.

A substantial number of sensors have been introduced, each of these sensors requires at least one algorithm to assess sensor output and determine whether the test-taker is cheating or not. Since the Monitor is provided with a chassis intrusion detector (CID), it is virtually impossible for a consultant to modify the apparatus to transmit the display information to another room, for example. With a CID, there are no accessible wires which connect the display to the electronics package, for example.

Finally, the display itself is protected. The test-taker can wear a camera which has a lens the size of a small pea but for that camera to see the display, it will also be seen by the iris imager or the eye-to-display cameras since there is a very limited viewing area for the camera to see the display.

Of course, if a cheating method is discovered, it will quickly become public through the Internet, defeating the Monitor solution. Therefore, a continuous improvement process which rewards test-takers who discover cheating methods can be implemented.

At the discretion of the institution, a time limit or no time limit can be afforded the test-taker for completing the test. Similarly, a course can have only a single final exam or a series of quizzes in addition to a midterm and final exam or feedback can be requested from the test-taker during each course session depending on the course and the desires of the institution. Since all such tests will be graded automatically, the cost of having daily or more frequent quizzes versus a single final exam is insignificant. In one extreme case, all the required courses can be given without any exams and a final comprehensive exam can be used to validate a student for receiving a degree. Alternately, the student can be tested continuously during the course or degree process without any final examinations. These decisions are left up to the institution. These options are facilitated due to the ability of the test-taker to observe instructions presented on the computer or Monitor screen and at arbitrary times be tested using the Monitor.

The test-taker can enter data into the testing program through the keyboard 708 (FIG. 18), a track pad (not shown), and/or the mouse 707, or any other type of user interface such as a touch screen of a laptop computer or smartphone 705 (see FIG. 17) when the device is connected thereto. The mouse 707 or keyboard 708 can be attached to a smartphone or computer 710 with a fixed wire or wirelessly. Test questions, however, will only be displayed on the Monitor display.

The test is preferably configured such that the answers do not provide information relative to the question. Therefore, someone viewing the answers cannot discern therefrom the questions. Therefore, the question answers do not need to be encrypted but can be sent in an on unencrypted form to the test providing institution.

For example, if the test providing institution is providing tests to 1000 students either simultaneously or at different times, and if the test is of a multiple-choice type and contains 50 questions, the order of the questions will be different for each test provided. Since this provides a very large number of different tests each containing the same questions, there is little risk that answers from one set of questions can be of any value to a student taking a different ordered set of the same questions.

Some important features of this invention differentiate it significantly from prior art attempts to develop secure testing systems. These include:
1. Use of a head-mounted display for presenting randomized questions to the test-taker in a manner that questions cannot be obtained or observed by another person. Such a display can be in the form of a small light emitting display held near the eye of the test-taker.
2. The same test is given to multiple test-takers wherein the order of the test questions is randomized to prevent passing of answers from one test-taker to another. Each test-taker can take the identical test but the questions are ordered differently.
3. The test-taking process is fully automatic and does not require human intervention. If the test-taker violates rules of the institution, the violation will be noted and provided to the test-taker. The institution will only get involved if the test-taker protests the results.
4. No video or audio data is forwarded to the test-taking institution. If the test was successfully completed, it is assumed that no cheating occurred. If the test is interrupted, diagnostic information can be retained and upon request of the institution, forwarded thereto for diagnostic purposes. In general, neither video nor audio information is stored during the test-taking process unless the test is interrupted.
5. No behavioral measurements are made, recorded, or sent to the institution and thus it is not necessary to try to interpret cheating activity based on behavioral or other measurements.
6. Test questions are only available to the display which are part of the inventive device (the Monitor) and protected using strong encryption and by the chassis intrusion detecting system.
7. Since it is virtually impossible for a consultant to observe a copy of the test, attempts to determine that a consultant is communicating with the test-taker other than by oral communications are unnecessary. Such communications from the consultant are impossible to reliably detect. Oral communications from the test-taker are forbidden and if detected by a contact microphone, for example, the test can be stopped.
8. The test encryption and decryption key set is created by the inventive device using a secret algorithm based on the iris code determined by the server. At the end of the test, the private key is destroyed. Since the only copy that exists is on the monitor and protected by the chassis intrusion detector, no other device can decrypt the test which has been created by the test-providing institution uniquely for the monitor.
9. Use of sophisticated neural network-based pattern recognition algorithms allow for continuous improvement of this system if and when new cheating methods are discovered.

This allows for upgrading software of the system as new improvements are implemented. In addition to multiple choice test, any of the monitors disclosed herein may be used for tests that require written answers. For such tests, the monitor is equipped preferably with a high definition display permitting multiple lines of text to be displayed. The monitor should also be capable of displaying a virtual keyboard preventing the test-taker from typing on a desk or table, for example, which will be observed by the forward-facing camera. Such a virtual keyboard is described in U.S. Ser. No. 10/180,572. When provided with a question requiring a text response, the test-taker will use the virtual keyboard on the display to type the answer which will then appear on the display. In this manner, a response by the test-taker cannot be observed by an associate looking over his shoulder while the test is being taken.

In some cases, a written response to a test will be required especially when a mathematical derivation or the hand writing of mathematical expressions is required. In such a case, the test-taker can be provided with a tablet onto which his hand-written response will be entered. The tablet will not show the test-taker's handwriting but will be linked to the monitor in such a manner that only the monitor receives the hand-written response. This response will be displayed on to the display for review and correction by the test taker.

Instead of using a Kerr or Pockets cell to black out a forward part of the display to prevent observance of the display through the glasses by an accomplice, electrochromic glass can be used for this function, as described in U.S. Ser. No. 10/180,572. In this case, the electrochromic glass will be turned totally black or opaque by a control mechanism so that the contents of the display cannot be seen from a person standing in front of the test-taker. Another approach is to use polarized lenses for the glasses and for the display where the angle of polarization is rotated 90 degrees. For example, the glasses can be vertically polarized and the display horizontally polarized. In this case, light from the display will not pass through the glasses preventing it from being observed by an accomplice standing in front of the test-taker.

Using the EKG system disclosed herein, an equipped monitor obtains a second biometric system for identifying the test-taker and for verifying that the test-taker is in fact wearing the monitor. Thus, in addition to the iris biometric, obtained by the iris camera, the EKG pads on opposite sides of the test-taker's head will record the shape of the heartbeat of the test-taker which is unique to that test-taker and thus is a biometric identifier of the test-taker.

In addition to using the mouse, the test-taker can use his voice to enter commands to the monitor. Although this could be used as an alternative to the mouse described above for answering test questions, it can also be used for other commands such as initiating the test or controlling the display of the test questions for example. The test-taker can say “next question”, “I need a break”, “test finished” etc. The contact microphone will pick up the words spoken by the test-taker and thus can perform the various commands. Voice entry can also be used for answering essay type questions where it is obvious that the test-taker is not using his voice to request help from an accomplice. In a version of the monitor, tiny microphones can be provided which are inserted into the ears of the test-taker in order to hear if the test-taker is using a speaker inserted into his ear. Such a speaker would be like a hearing aid. Such microphones can be tiny devices measuring no more than a cubic millimeter. They can be inserted into the test-taker's ear when the test-taker is wearing the monitor. Such microphones will also pick up the voice of the test-taker and therefore on command of the monitor that test-taker can say something to test that the in-ear microphones are properly installed. Talking can also be used to test operation of the contact microphone, although, as described above, other tests based on the contact speaker and the EKG devices are provided for this function.

Scrambling of the order of the test questions is described above. Additionally, multiple-choice answers to the test questions can be similarly scrambled.

Other methods can be used with the monitor to permit the test-taker to enter commands to the monitor. One such method using the iris camera is track the motion of the eye which is usable to select answers to the questions or to control the operation of the monitor. Eye blinking and time or duration of closing also can be used for this purpose. Another such method is to use gestures which can be seen by the forward-facing camera and interpreted by appropriate software. Teeth clicking, for example, can be used for controlling the test and in particular for choosing various of the multiple choices for a test question.

The lenses of the glasses can be made easily replaceable permitting different prescription lenses to be used for different test-takers.

Disclosed herein are a series of measures that are designed to prevent transfer of test-related information to anyone other than the test-taker by any means either visually, electronically, or wirelessly. Measures disclosed herein are not exhaustive and the intent of this invention is to cover preferred implementations of such techniques. Similarly, disclosed herein are a series of measures to prevent information from being transmitted to a test-taker on the assumption that the information about the test has leaked to a consultant. Since the consultant now must transmit to the test-taker information which will affect how the test-taker answers the question, this invention has also not exhaustively disclosed all possibilities of information transferal from the consultant but only representative cases.

It is not the intent of the inventors to cover all such transferal means including, for example, haptic methods which have not been discussed above. These include, for example, a wire attached to the test-taker and physically held by the consultant who may in fact be in another room wherein the wire travels through a hole in a wall. In this case, for example, if the consultant knows the test question and has determined that the proper answer is 3 then the consultant could pull three times on the wire thereby transmitting this information to the test-taker. All sorts of similar haptic techniques exist including electrically actuated vibrators, spark creators etc. To cover all such possibilities of either the leaks of information out of the test-taking device or the communication of information to the test-taker would require volumes. Thus, it is the intent of the inventor to cover all such possibilities while disclosing those that are most readily implemented.

Finally, all patents, patent application publications and non-patent material identified above are incorporated by reference herein. The features disclosed in this material may be used in the invention to the extent possible.

Although several preferred embodiments are illustrated and described above, there are possible combinations using other geometries, sensors, materials and different dimensions for the components that perform the same functions. At least one of the inventions disclosed herein is not limited to the above embodiments and should be determined by the following claims. There are also numerous additional applications in addition to those described above. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention which is limited only by the following claims.

1. A system; comprising:
a frame adapted to be placed onto a head of a wearer at least partly in front of eyes of the wearer;
a housing attached to said frame;
an assembly arranged in said housing; and
said assembly comprising:
a display oriented rearward, whereby said display is viewable by the wearer when said frame is on the head of the wearer; and
a processor coupled to and monitoring said contact microphone for vibrations,
whereby the system is usable for testing by directing said processor to display questions on said display, receive answers via a user interface coupled to said processor, and detect talking or other sounds emitted by the person taking the test using the system which is indicative of cheating on the test by monitoring vibrations detected by said contact microphone.

2. The system of claim 1, further comprising a chassis intrusion detector arranged in conjunction with said housing to detect an attempt to intrude into said housing or contents thereof,

3. The system of claim 1, wherein said housing comprises a printed circuit board and a connector electrically coupled to said printed circuit board and configured to enable connection to an external cable, said chassis intrusion detector covering said printed circuit board, said connector including pins that pass through holes in said chassis intrusion detector.

4. The system of claim 1, wherein said assembly further comprises a contact microphone arranged on said frame in a position to contact a face of a wearer of the system when said frame is on the head of the wearer and detect vibrations of a bone or facial skin of the wearer when in said position;

5. The system of claim 4, further comprising at least one component that determines whether said contact microphone is operatively in contact with skin of the wearer when said support portion is on the head of the wearer.

6. The system of claim 4, further comprising a spring extending from said housing inward, said contact microphone being arranged proximate an inward end of said spring.

7. The system of claim 4, further comprising a sound generator coupled to said processor and being controlled by said processor to generate a sound, whereby said processor operatively analyzes reception of the sound generated by said sound generator and received by said contact microphone to assess whether the system is in a proper operational position.

8. The system of claim 7, wherein said sound generator is movably arranged on said second side of said frame, further comprising a wire that connects said sound generator to said housing.

9. The system of claim 4, further comprising an EKG sensor in the form of a thin film arranged on top of said contact microphone and a thin film on top of said sound generator, said processor being coupled to said EKG sensor to obtain information about a heartbeat of the wearer when said frame is on the head of the wearer.

10. The system of claim 1, wherein said assembly further comprises a biometric sensor arranged at least partly in said housing to obtain biometric data, said processor being coupled to and monitoring said biometric sensor for a change in biometric data, whereby when the system is usable for testing, said processor confirms identity of a person taking a test using the system by analyzing biometric data obtained by said biometric sensor.
